(19) United States
(12) Patent Application Publication
(10) Pub. No.: US 2024/0195516 A1
(43) Pub. Date: Jun. 13, 2024

(54) WIRELESS MEDIA DEVICE, AND IMAGE DISPLAY APPARATUS INCLUDING THE SAME

(71) Applicant: LG ELECTRONICS INC., Seoul (KR)

(72) Inventor: Byunguk KWON, Seoul (KR)

(73) Assignee: LG ELECTRONICS INC., Seoul (KR)

(21) Appl. No.: 18/523,467

(22) Filed: Nov. 29, 2023

(30) Foreign Application Priority Data
Dec. 13, 2022 (KR) 10-2022-0173531
Mar. 13, 2023 (KR) 10-2023-0032712

(51) Int. Cl. H04B 17/309; H04B 17/10

(52) U.S. Cl. CPC H04B 17/309; H04B 17/101

(57) ABSTRACT

The present disclosure relates to a wireless media device including a signal processing device configured to process an image signal or an audio signal; and a transceiver device configured to wirelessly transmit a signal from the signal processing device to a display device, wherein the transceiver device is configured to select a beam candidate group based on link quality between the wireless media device and the display device, manage the beam candidate group, and perform beam selection based on a plurality of candidate beams in the beam candidate group. Accordingly, beam tracking can be efficiently performed.

### CROSS-REFERENCE TO RELATED APPLICATIONS

Pursuant to 35 U.S.C. § 119(a), this application claims the benefit of earlier filing date and right of priority to Korean Patent Application Nos. 10-2022-0173531, filed on Dec. 13, 2022, and 10-2023-0032712, filed on Mar. 13, 2023, the contents of which are all hereby incorporated by reference herein in their entireties.

### BACKGROUND

### 1. Field

The present disclosure relates to an image display apparatus, and more particularly, to an image display apparatus capable of efficiently performing beam tracking.

### 2. Description of the Related Art

Image display apparatuses display images through displays.

Meanwhile, sound may be output through an audio output device in addition to an image through image display apparatuses.

Meanwhile, in order to output image on the displays of the image display apparatuses, a signal processing device performs image signal processing and the like.

Recently, for ease of use, a method of separating a display and a signal processing device in an image display apparatus and performing media transmission between the display and the signal processing device by a wireless communication method rather than a wired communication method has been studied.

Meanwhile, in case in which beam tracking is performed by a request for media transmission based on a wireless communication method, a considerable period of time is required for beam selection.

### SUMMARY

An object of the present disclosure is to provide a wireless media device capable of efficiently performing beam tracking and an image display apparatus including the same.

Another object of the present disclosure is to provide a wireless media device capable of quickly performing beam tracking using a beam candidate group and an image display apparatus including the same.

Another object of the present disclosure is to provide a wireless media device capable of efficiently performing beam tracking according to a wireless environment and an image display apparatus including the same.

In accordance with the present disclosure, the above and other objects may be accomplished by the provision of a wireless media device including: a signal processing device configured to process an image signal or an audio signal; and a transceiver device configured to wirelessly transmit a signal from the signal processing device to a display device, wherein the transceiver device is configured to select a beam candidate group based on link quality between the wireless media device and the display device, manage the beam candidate group, and perform beam selection based on a plurality of candidate beams in the beam candidate group.

The transceiver device may be configured to periodically measure the link quality of the plurality of candidate beams in the beam candidate group and update the plurality of candidate beams in the beam candidate group based on the measured link quality.

The transceiver device may be configured to perform the beam selection within the beam candidate group in case in which there is a valid beam among the plurality of candidate beams in the beam candidate group or in case in which measured link quality is greater than or equal to a reference value.

The transceiver device may be configured to perform the beam selection based on a best beam in case in which link quality measured for the plurality of candidate beams in the beam candidate group is less than a reference value.

The transceiver device may be configured to update the beam candidate group based on first beam tracking performed during a first period or second beam tracking performed during a second period longer than the first period, based on a wireless environment between the wireless media device and the display device.

The transceiver device may be configured to manage the beam candidate group through beam grouping.

The transceiver device may be configured to identify a plurality of regions for the beam candidate group, select candidate beams from some of the plurality of regions, and manage the selected candidate beams.

The transceiver device may be configured to select a first number of beams as candidates in a first region to which a first beam belongs among the plurality of regions, select a second number of beams as candidates in a second region adjacent to the first region in a first direction, among the plurality of regions, and select a third number of beams as candidates in a third region adjacent to the first region in a second direction, among the plurality of regions, wherein the second number is greater than the first number, and the second number is greater than the third number.

The third number may be greater than the first number.

The plurality of regions may further include a fourth region in which the candidate beam is not selected.

The transceiver device may be configured to identify 9 regions based on a 3×3 matrix for the beam candidate group, select candidate beams from 5 regions among the 9 regions, and manage the selected candidate beams.

The transceiver device may be configured to select a candidate beam having a highest measured link quality in the beam candidate group in case in which there is a valid beam in the plurality of candidate beams in the beam candidate group and measured link quality is greater than or equal to a reference value.

The transceiver device may be configured to perform the first beam tracking based on the plurality of candidate beams in the beam candidate group.

The transceiver device may be configured to update the beam candidate group by measuring link quality for the beam candidate group and beams other than the beam candidate group, in case in which performing the second beam tracking.

The transceiver device may be configured to add a best beam selected based on the second beam tracking, a beam currently in use, and a previous best beam to the beam candidate group and manage the beams.

In case in which at least one of the wireless media device or the display device is moved while performing beam tracking based on the plurality of candidate beams in the beam candidate group, the transceiver device is configured to update the beam candidate group by measuring link quality for the beam candidate group and beams other than the beam candidate group.

The transceiver device may be configured to transmit a first signal based on a beam having a first shape in which a sector is sequentially varied during a first period, receive a second signal based on the beam having the first shape from the display device during a third period according to selection of the wireless media device of the display device during a second period, approve association with the display device based on network address information in the second signal during a fourth period, transmit a third signal based on a beam having a second shape at an angle smaller than that of the first shape during a fifth period, and transmit wireless media to the display device based on the beam having the second shape during a sixth period.

In accordance with an aspect of the present disclosure, the above and other objects may be accomplished by the provision of a wireless media device including: a signal processing device configured to process an image signal or an audio signal; and a transceiver device configured to wirelessly transmit a signal from the signal processing device to a display device, wherein the transceiver device is configured to identify a plurality of regions for a beam candidate group based on link quality between the wireless media device and the display device, select candidate beams from some of the plurality of regions, and manage the selected candidate beams.

The transceiver device may be configured to select a first number of beams as candidates in a first region to which a first beam belongs among the plurality of regions, select a second number of beams as candidates in a second region adjacent to the first region in a first direction, among the plurality of regions, and select a third number of beams as candidates in a third region adjacent to the first region in a second direction, among the plurality of regions, wherein the second number is greater than the first number, and the second number is greater than the third number.

In accordance with an aspect of the present disclosure, the above and other objects may be accomplished by the provision of a wireless media device including: a signal processing device configured to process an image signal or an audio signal; and a transceiver device configured to wirelessly transmit a signal from the signal processing device to a display device, wherein the transceiver device is configured to perform first beam tracking during a first period or perform second beam tracking during a second period longer than the first period, based on a wireless environment between the wireless media device and the display device.

In accordance with an aspect of the present disclosure, the above and other objects may be accomplished by the provision of an image display apparatus including: a display device; and a wireless media device configured to wirelessly communicate with the display device, wherein the wireless media device includes: a signal processing device configured to process an image signal or an audio signal; and a transceiver device configured to wirelessly transmit a signal from the signal processing device to a display device, wherein the transceiver device is configured to select a beam candidate group based on link quality between the wireless media device and the display device, manage the beam candidate group, and perform beam selection based on a plurality of candidate beams in the beam candidate group.

In accordance with an aspect of the present disclosure, the above and other objects may be accomplished by the provision of an image display apparatus including: a display device; and a wireless media device configured to wirelessly communicate with the display device, wherein the wireless media device includes: a signal processing device configured to process an image signal or an audio signal; and a transceiver device configured to wirelessly transmit a signal from the signal processing device to a display device, wherein the transceiver device is configured to identify a plurality of regions for a beam candidate group based on link quality between the wireless media device and the display device, select candidate beams from some of the plurality of regions, and manage the selected candidate beams.

In accordance with an aspect of the present disclosure, the above and other objects may be accomplished by the provision of an image display apparatus including: a display device; and a wireless media device configured to wirelessly communicate with the display device, wherein the wireless media device includes: a signal processing device configured to process an image signal or an audio signal; and a transceiver device configured to wirelessly transmit a signal from the signal processing device to a display device, wherein the transceiver device is configured to perform first beam tracking during a first period or perform second beam tracking during a second period longer than the first period based on a wireless environment between the wireless media device and the display device.

### Effects of the Disclosure

The wireless media device according to an embodiment of the present disclosure includes a signal processing device configured to process an image signal or an audio signal; and a transceiver device configured to wirelessly transmit a signal from the signal processing device to a display device, wherein the transceiver device is configured to select a beam candidate group based on link quality between the wireless media device and the display device, manage the beam candidate group, and perform beam selection based on a plurality of candidate beams in the beam candidate group. Accordingly, beam tracking can be efficiently performed. Furthermore, beam tracking may be quickly performed using the beam candidate group.

Meanwhile, the transceiver device may be configured to periodically measure the link quality of the plurality of candidate beams in the beam candidate group and update the plurality of candidate beams in the beam candidate group based on the measured link quality. Accordingly, beam tracking can be efficiently performed. Furthermore, beam tracking may be quickly performed using the beam candidate group.

Meanwhile, the transceiver device may be configured to perform the beam selection within the beam candidate group in case in which there is a valid beam among the plurality of candidate beams in the beam candidate group or in case in which measured link quality is greater than or equal to a reference value. Accordingly, beam tracking can be efficiently performed. Furthermore, beam tracking may be quickly performed using the beam candidate group.

Meanwhile, the transceiver device may be configured to perform the beam selection based on a best beam in case in which link quality measured for the plurality of candidate beams in the beam candidate group is less than a reference value. Accordingly, beam tracking can be efficiently performed. Furthermore, beam tracking can be efficiently performed depending on a wireless environment.

Meanwhile, the transceiver device may be configured to update the beam candidate group based on first beam tracking performed during a first period or second beam tracking performed during a second period longer than the first period, based on a wireless environment between the wireless media device and the display device. Accordingly, beam tracking can be efficiently performed. Furthermore, beam tracking can be efficiently performed depending on a wireless environment.

Meanwhile, the transceiver device may be configured to manage the beam candidate group through beam grouping. Accordingly, beam tracking can be efficiently performed. Furthermore, beam tracking may be quickly performed using the beam candidate group.

Meanwhile, the transceiver device may be configured to identify a plurality of regions for the beam candidate group, select candidate beams from some of the plurality of regions, and manage the selected candidate beams. Accordingly, beam tracking can be efficiently performed. Furthermore, beam tracking may be quickly performed using the beam candidate group.

Meanwhile, the transceiver device may be configured to select a first number of beams as candidates in a first region to which a first beam belongs among the plurality of regions, select a second number of beams as candidates in a second region adjacent to the first region in a first direction, among the plurality of regions, and select a third number of beams as candidates in a third region adjacent to the first region in a second direction, among the plurality of regions, wherein the second number is greater than the first number, and the second number is greater than the third number. Accordingly, beam tracking can be efficiently performed. Furthermore, beam tracking may be quickly performed using the beam candidate group.

Meanwhile, the third number may be greater than the first number. Accordingly, beam tracking can be efficiently performed. Furthermore, beam tracking may be quickly performed using the beam candidate group.

Meanwhile, the plurality of regions may further include a fourth region in which the candidate beam is not selected. Accordingly, beam tracking can be efficiently performed.

Meanwhile, the transceiver device may be configured to identify 9 regions based on a 3×3 matrix for the beam candidate group, select candidate beams from 5 regions among the 9 regions, and manage the selected candidate beams. Accordingly, beam tracking can be efficiently performed. Furthermore, beam tracking may be quickly performed using the beam candidate group.

Meanwhile, the transceiver device may be configured to select a candidate beam having a highest measured link quality in the beam candidate group in case in which there is a valid beam in the plurality of candidate beams in the beam candidate group and measured link quality is greater than or equal to a reference value. Accordingly, beam tracking can be efficiently performed. Furthermore, beam tracking may be quickly performed using the beam candidate group.

Meanwhile, the transceiver device may be configured to perform the first beam tracking based on the plurality of candidate beams in the beam candidate group. Accordingly, beam tracking can be efficiently performed. Furthermore, beam tracking may be quickly performed using the beam candidate group.

Meanwhile, the transceiver device may be configured to update the beam candidate group by measuring link quality for the beam candidate group and beams other than the beam candidate group, in case in which performing the second beam tracking. Accordingly, beam tracking can be efficiently performed. Furthermore, beam tracking can be efficiently performed depending on a wireless environment.

Meanwhile, the transceiver device may be configured to add a best beam selected based on the second beam tracking, a beam currently in use, and a previous best beam to the beam candidate group and manage the beams. Accordingly, beam tracking can be efficiently performed. Furthermore, beam tracking can be efficiently performed depending on a wireless environment.

Meanwhile, in case in which at least one of the wireless media device or the display device is moved while performing beam tracking based on the plurality of candidate beams in the beam candidate group, the transceiver device is configured to update the beam candidate group by measuring link quality for the beam candidate group and beams other than the beam candidate group. Accordingly, beam tracking can be efficiently performed. Furthermore, beam tracking can be efficiently performed depending on a wireless environment.

Meanwhile, the transceiver device may be configured to transmit a first signal based on a beam having a first shape in which a sector is sequentially varied during a first period, receive a second signal based on the beam having the first shape from the display device during a third period according to selection of the wireless media device of the display device during a second period, approve association with the display device based on network address information in the second signal during a fourth period, transmit a third signal based on a beam having a second shape at an angle smaller than that of the first shape during a fifth period, and transmit wireless media to the display device based on the beam having the second shape during a sixth period. Accordingly, media data may be stably transmitted wirelessly.

The wireless media device according to another embodiment of the present disclosure includes a signal processing device configured to process an image signal or an audio signal; and a transceiver device configured to wirelessly transmit a signal from the signal processing device to a display device, wherein the transceiver device is configured to identify a plurality of regions for a beam candidate group based on link quality between the wireless media device and the display device, select candidate beams from some of the plurality of regions, and manage the selected candidate beams. Accordingly, beam tracking can be efficiently performed. Furthermore, beam tracking may be quickly performed using the beam candidate group.

Meanwhile, the transceiver device may be configured to select a first number of beams as candidates in a first region to which a first beam belongs among the plurality of regions, select a second number of beams as candidates in a second region adjacent to the first region in a first direction, among the plurality of regions, and select a third number of beams as candidates in a third region adjacent to the first region in a second direction, among the plurality of regions, wherein the second number is greater than the first number, and the second number is greater than the third number. Accordingly, beam tracking can be efficiently performed. Furthermore, beam tracking may be quickly performed using the beam candidate group.

The wireless media device according to another embodiment of the present disclosure includes a signal processing device configured to process an image signal or an audio signal; and a transceiver device configured to wirelessly transmit a signal from the signal processing device to a display device, wherein the transceiver device is configured to perform first beam tracking during a first period or perform second beam tracking during a second period longer than the first period, based on a wireless environment between the wireless media device and the display device. Accordingly, beam tracking can be efficiently performed. Furthermore, beam tracking can be efficiently performed depending on a wireless environment.

The image display apparatus according to another embodiment of the present disclosure includes a display device; and a wireless media device configured to wirelessly communicate with the display device, wherein the wireless media device includes: a signal processing device configured to process an image signal or an audio signal; and a transceiver device configured to wirelessly transmit a signal from the signal processing device to a display device, wherein the transceiver device is configured to select a beam candidate group based on link quality between the wireless media device and the display device, manage the beam candidate group, and perform beam selection based on a plurality of candidate beams in the beam candidate group. Accordingly, beam tracking can be efficiently performed. Furthermore, beam tracking may be quickly performed using the beam candidate group.

The image display apparatus according to another embodiment of the present disclosure includes a display device; and a wireless media device configured to wirelessly communicate with the display device, wherein the wireless media device includes: a signal processing device configured to process an image signal or an audio signal; and a transceiver device configured to wirelessly transmit a signal from the signal processing device to a display device, wherein the transceiver device is configured to identify a plurality of regions for a beam candidate group based on link quality between the wireless media device and the display device, select candidate beams from some of the plurality of regions, and manage the selected candidate beams. Accordingly, beam tracking can be efficiently performed. Furthermore, beam tracking may be quickly performed using the beam candidate group.

The image display apparatus according to another embodiment of the present disclosure includes a display device; and a wireless media device configured to wirelessly communicate with the display device, wherein the wireless media device includes: a signal processing device configured to process an image signal or an audio signal; and a transceiver device configured to wirelessly transmit a signal from the signal processing device to a display device, wherein the transceiver device is configured to perform first beam tracking during a first period or perform second beam tracking during a second period longer than the first period based on a wireless environment between the wireless media device and the display device. Accordingly, beam tracking can be efficiently performed. Furthermore, beam tracking can be efficiently performed depending on a wireless environment.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram showing an image display apparatus according to an embodiment of the present disclosure;

FIG. 2 is an internal block diagram of an image display apparatus according to an embodiment of the present disclosure;

FIG. 3 is an internal block diagram of a signal processing device of FIG. 2;

FIG. 4A is a diagram showing a method of controlling a remote controller of FIG. 2;

FIG. 4B is an internal block diagram of the remote controller of FIG. 2;

FIG. 5 is an internal block diagram of a display of FIG. 2;

FIGS. 6A and 6B are diagrams referred to in the description of an organic light emitting diode panel of FIG. 5;

FIG. 7 is a diagram referred to in the description of a transceiver device of FIG. 2 and a second transceiver device;

FIG. 8 is a flowchart illustrating an operation of an image display apparatus;

FIG. 9 is a diagram referred to in the description of FIG. 8;

FIGS. 10A to 12C are diagrams referred to in the description of an operation of a wireless media device related to the present disclosure;

FIG. 13 is a flowchart illustrating an operation of a wireless media device according to an embodiment of the present disclosure; and

FIGS. 14 to 16 are diagrams referred to in the description of FIG. 13.

### DETAILED DESCRIPTION OF THE PREFERRED EMBODIMENTS

Hereinafter, the present disclosure will be described in detail with reference to the accompanying drawings.

Regarding constituent elements used in the following description, suffixes “module” and “unit” are given only in consideration of ease in the preparation of the specification, and do not have or serve as different meanings. Accordingly, the suffixes “module” and “unit” may be used interchangeably.

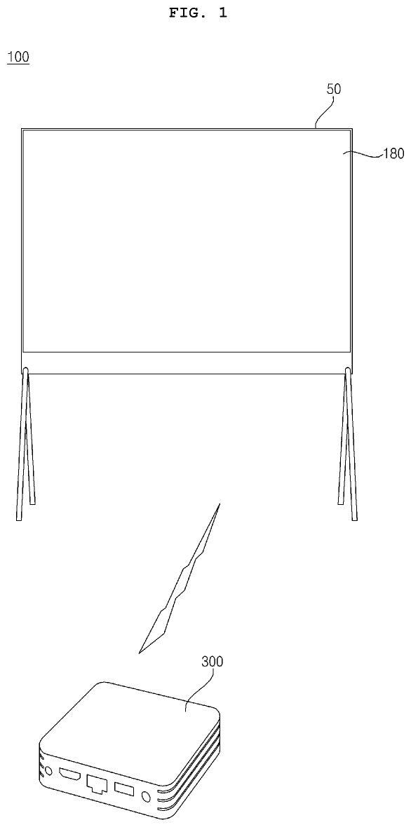

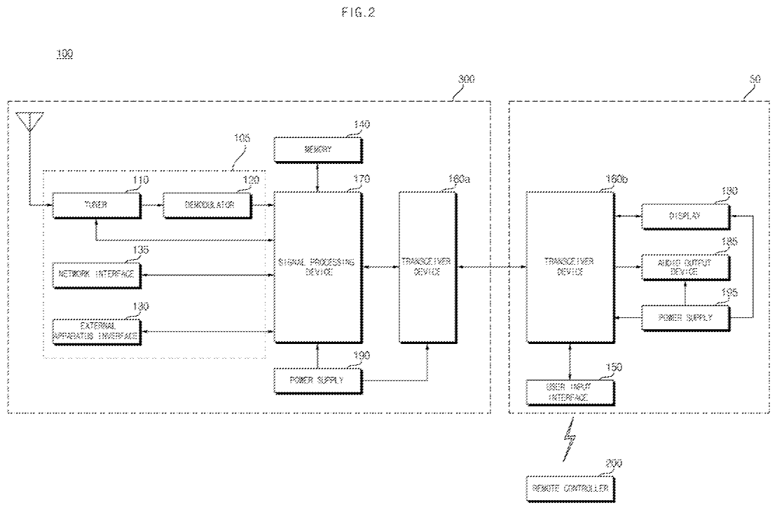

FIG. 1 is a diagram showing an image display apparatus according to an embodiment of the present disclosure.

Referring to FIG. 1, an image display apparatus 100 according to an embodiment of the present disclosure includes a display device 50 and a wireless media device 300.

The wireless media device 300 and the display device 50 in the image display apparatus 100 according to an embodiment of the present disclosure are separated from each other and wirelessly transmit and receive media.

Meanwhile, the wireless media device 300 in the image display apparatus 100 may wirelessly transmit an image signal or an audio signal to the display device 50 using a non-compression method.

For example, the wireless media device 300 in the image display apparatus 100 may transmit an image signal or an audio signal to the display device 50 based on wireless communication based on the 802.11 ad/ay standard.

When the wireless media device 300 transmits an uncompressed image signal or audio signal to the display device 50, the wireless media device 300 may transmit media data to the display device 50 using a frequency based on 60 GHz in order to secure a stable wireless bandwidth.

Meanwhile, for wireless communication between the wireless media device 300 and the display device 50, beam tracking is performed.

When beam tracking is performed at the request of the wireless media device 300 or the display device 50, a considerable period of time is required for beam selection. Accordingly, in the present disclosure, a method for efficiently performing beam tracking is proposed.

To this end, the wireless media device 300 according to an embodiment of the present disclosure selects a beam candidate group based on link quality between the wireless media device 300 and the display device 50, manages the beam candidate group, and performs beam selection based on a plurality of candidate beams in the beam candidate group. Accordingly, beam tracking can be efficiently performed. Furthermore, beam tracking may be quickly performed using the beam candidate group.

Meanwhile, the wireless media device 300 according to another embodiment of the present disclosure identifies a plurality of regions for a beam candidate group based on the link quality between the wireless media device 300 and the display device 50, selects a candidate beam from some of the plurality of regions, and manages the selected candidate beam. Accordingly, beam tracking can be efficiently performed. Furthermore, beam tracking may be quickly performed using the beam candidate group.

Meanwhile, in the wireless media device 300 according to another embodiment of the present disclosure performs first beam tracking performed during a first period or second beam tracking performed during a second period longer than the first period based on a wireless environment between the wireless media device 300 and the display device 50. Accordingly, beam tracking can be efficiently performed. Furthermore, beam tracking can be efficiently performed depending on the wireless environment.

Meanwhile, the display device 50 according to an embodiment of the present disclosure selects a beam candidate group based on link quality between the wireless media device 300 and the display device 50, manages the beam candidate group, and performs beam selection based on a plurality of candidate beams in the beam candidate group. Accordingly, beam tracking can be efficiently performed. Furthermore, beam tracking may be quickly performed using the beam candidate group.

Meanwhile, the display device 50 according to another embodiment of the present disclosure may identify a plurality of regions for a beam candidate group based on the link quality between the wireless media device 300 and the display device 50, select candidate beams from some of a plurality regions, and manage the selected candidate beams. Accordingly, beam tracking can be efficiently performed. Furthermore, beam tracking may be quickly performed using the beam candidate group.

Meanwhile, the display device 50 according to another embodiment of the present disclosure may perform first beam tracking performed during a first period and second beam tracking performed during a second period longer than the first period based on the wireless environment between the wireless media device 300 and the display device 50. Accordingly, beam tracking can be efficiently performed. Furthermore, beam tracking can be efficiently performed depending on the wireless environment.

FIG. 2 is an internal block diagram of an image display apparatus according to an embodiment of the present disclosure.

Referring to FIG. 2, the image display apparatus 100 according to an embodiment of the present disclosure includes the wireless media device 300 and the display device 50.

The wireless media device 300 may include an image receiver 105, a memory 140, a power supply 190, a signal processing device 170, and a transceiver device 160a.

The display device 50 may include a second transceiver device 160b, a user input interface 150, a display 180, an audio output device 185, and a power supply 195.

The image receiver 105 may include a tuner 110, a demodulator 120, a network interface 135, and an external apparatus device 130.

The tuner 110 selects an RF broadcast signal corresponding to a channel selected by a user or all pre-stored channels among radio frequency (RF) broadcast signals received through an antenna (not shown). In addition, the selected RF broadcast signal is converted into an intermediate frequency signal, a baseband image, or an audio signal.

For example, if the selected RF broadcast signal is a digital broadcast signal, the digital broadcast signal is converted into a digital IF signal (DIF), and if the selected RF broadcast signal is an analog broadcast signal, the analog broadcast signal is converted into an analog baseband image or audio signal (CVBS/SIF). That is, the tuner 110 may process the digital broadcast signal or an analog broadcast signal. The analog baseband image or audio signal (CVBS/SIF) output from the tuner 110 may be directly input to the signal processing device 170.

Meanwhile, the tuner 110 may include a plurality of tuners for receiving broadcast signals of a plurality of channels. Alternatively, a single tuner that simultaneously receives broadcast signals of a plurality of channels is also available.

The demodulator 120 receives the converted digital IF signal DIF from the tuner 110 and performs a demodulation operation.

The demodulator 120 may perform demodulation and channel decoding and then output a stream signal TS. At this time, the stream signal may be a multiplexed signal of an image signal, an audio signal, or a data signal.

The stream signal output from the demodulator 120 may be input to the signal processing device 170. The signal processing device 170 performs demultiplexing, image/audio signal processing, and the like, and then outputs an image to the display 180 and outputs audio to the audio output device 185.

The external apparatus interface 130 may transmit or receive data to and from a connected external apparatus (not shown). To this end, the external apparatus interface 130 may include an A/V input/output device (not shown) or a wireless communication unit (not shown).

The external apparatus interface 130 may be connected in wired or wirelessly to an external apparatus, such as a digital versatile disk (DVD), a Blu ray, a game equipment, a camera, a camcorder, a computer (note book), a set-top box, and USB device, and may perform an input/output operation with an external apparatus.

The A/V input and output device may receive image and audio signals from an external apparatus. Meanwhile, a wireless transceiver may perform short-range wireless communication with other electronic apparatus.

The network interface 135 provides an interface for connecting the image display apparatus 100 to a wired/wireless network including the Internet network. For example, the network interface 135 may receive, via the network, content or data provided by the Internet, a content provider, or a network operator.

The memory 140 may store a program for each signal processing and control in the signal processing device 170, and may store signal-processed image, audio, or data signal.

In addition, the memory 140 may serve to temporarily store image, audio, or data signal input to the external apparatus interface 130. In addition, the memory 140 may store information on a certain broadcast channel through a channel memory function, such as a channel map.

Although FIG. 2 illustrates that the memory is provided separately from the signal processing device 170, the scope of the present disclosure is not limited thereto. The memory 140 may be included in the signal processing device 170.

The signal processing device 170 may demultiplex an input stream through the tuner 110, the demodulator 120, or the external apparatus interface 130, or process demultiplexed signals to generate and output a signal for image or audio output.

The image signal processed by the signal processing device 170 is input to the display 180, and may be displayed as an image corresponding to the image signal. In addition, the image signal processed by the signal processing device 170 may be input to the external output apparatus through the external apparatus interface 130.

The audio signal processed by the signal processing device 170 may be output to the audio output device 185 as an audio signal. In addition, audio signal processed by the signal processing device 170 may be input to the external output apparatus through the external apparatus interface 130.

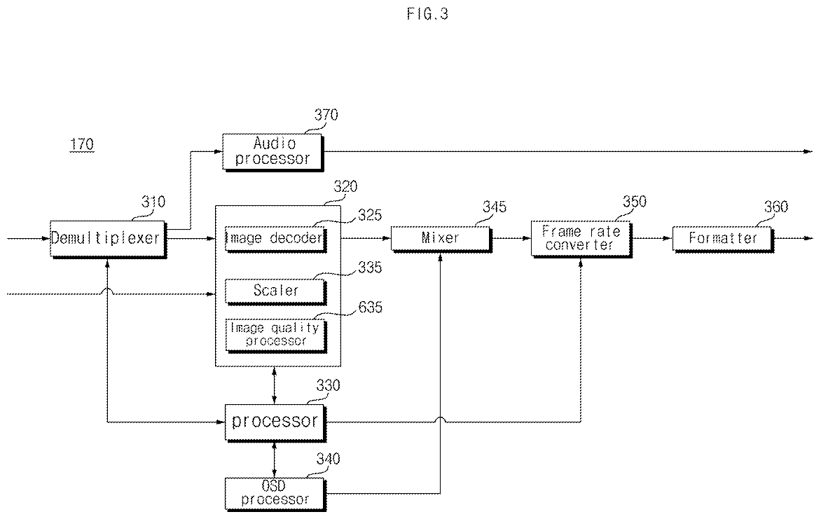

Although not shown in FIG. 2, the signal processing device 170 may include a demultiplexer, an image processor, and the like. This will be described later with reference to FIG. 3.

In addition, the signal processing device 170 may control the overall operation of the image display apparatus 100. For example, the signal processing device 170 may control the tuner 110 to control the tuning of the RF broadcast corresponding to the channel selected by the user or the previously stored channel.

In addition, the signal processing device 170 may control the image display apparatus 100 according to a user command input through the user input interface 150 or an internal program.

Meanwhile, the signal processing device 170 may control the display 180 to display an image. At this time, the image displayed on the display 180 may be a still image or a moving image.

Meanwhile, the signal processing device 170 may recognize the position of the user based on the image photographed by a photographing device (not shown). For example, the distance (z-axis coordinate) between a user and the image display apparatus 100 may be determined. In addition, the x-axis coordinate and the y-axis coordinate in the display 180 corresponding to a user position may be determined.

Meanwhile, although not shown in the figure, a channel browsing processor generating a thumbnail image corresponding to a channel signal or an external input signal may be further provided. The channel browsing processor may receive a stream signal (TS) output from the demodulator 120 or a stream signal output from the external apparatus device 130, extract an image from the input stream signal, and generate a thumbnail image.

The generated thumbnail image may be stream-decoded together with the decoded image and input to the signal processing device 170. The signal processing device 170 may display a thumbnail list including a plurality of thumbnail images on the display 180 using the input thumbnail image.

At this time, the thumbnail list may be displayed in a simple view manner in which the thumbnail list is displayed in a partial region in a state in which a certain image is displayed on the display 180, or may be displayed in a full view manner in which the thumbnail list is displayed in most regions of the display 180. Thumbnail images in the thumbnail list may be sequentially updated.

The power supply 190 supplies corresponding power throughout the wireless media device 300. In particular, the power supply 190 may supply power to the signal processing device 170, which may be implemented in the form of a system on chip (SOC), the transceiver device 160a for communication, the image receiver 105, and the memory 140.

Meanwhile, the power supply 190 may include a converter that converts AC power into DC power and a dc/dc converter that converts a level of DC power.

The transceiver device 160a may perform wireless communication with the second transceiver device 160b in the display device 50.

The second transceiver device 160b may perform wireless communication with the transceiver device 160a within the wireless media device 300.

An image signal and an audio signal received by the second transceiver device 160b may be transmitted to the display 180 and the audio output device 185, respectively.

The display 180 generates a driving signal by converting an image signal, a data signal, an OSD signal, a control signal processed by the signal processing device 170, an image signal, a data signal, a control signal, and the like received from the external apparatus interface 130.

The display 180 may be an LCD, OLED, inorganic LED, flexible display, or the like, and may also be a 3D display.

Meanwhile, the display 180 may be configured as a touch screen and used as an input device in addition to an output device.

The audio output device 185 converts the audio signal received from the second transceiver device 160b into sound and outputs the sound.

Meanwhile, the audio output device 185 may include at least one speaker.

Meanwhile, the power supply 195 supplies corresponding power throughout the display device 50. In particular, the power supply 195 may supply power to each of the second transceiver device 160b for communication, the display 180, the audio output device 185, and the user input interface 150.

Meanwhile, the power supply 195 may include a converter that converts AC power into DC power, and a dc/dc converter that converts a level of DC power.

The user input interface 150 may transmit a signal input by the user to the second transceiver device 160b. Then, the second transceiver device 160b may wirelessly transmit the signal input by the user to the transceiver device 160a, and the signal processing device 170 may receive the signal input by the user through the transceiver device 160a.

For example, a user input signal, such as power ON/OFF, channel selection, and screen setting, from the remote controller 200 or a user input signal input from a local key (not shown), such as power key, channel key, volume key, and set value, may be transmitted to the signal processing device 170 via the second transceiver device 160b and the transceiver device 160a.

Meanwhile, the signal processing device 170 may transmit various types of information or signals to the remote controller 200 via the transceiver device 160a, the second transceiver device 160b, and the user input interface 150.

The remote controller 200 transmits the user input to the user input interface 150. To this end, the remote controller 200 may use Bluetooth, a radio frequency (RF) communication, an infrared (IR) communication, an Ultra Wideband (UWB), ZigBee, or the like. In addition, the remote controller 200 may receive the image, audio, or data signal output from the user input interface 150, and display it on the remote controller 200 or output it as an audio.

Meanwhile, the image display apparatus 100 may be a fixed or mobile digital broadcast receiver capable of receiving digital broadcast.

Meanwhile, a block diagram of the image display apparatus 100 shown in FIG. 2 is a block diagram for an embodiment of the present disclosure. Each component of the block diagram may be integrated, added, or omitted according to a specification of the image display apparatus 100 actually implemented. That is, two or more components may be combined into a single component as needed, or a single component may be split into two or more components. The function performed in each block is described for the purpose of illustrating embodiments of the present disclosure, and specific operation and apparatus do not limit the scope of the present disclosure.

FIG. 3 is an internal block diagram of the signal processing device in FIG. 2.

Referring to the figure, the signal processing device 170 according to an embodiment of the present disclosure may include a demultiplexer 310, an image processor 320, a processor 330, an OSD processor 340, a mixer 345, a frame rate converter 350, a formatter 360, and an audio processor 370. In addition, the signal processing device 170 may further include an audio processor 370 and a data processor (not shown).

The demultiplexer 310 demultiplexes the input stream. For example, in case in which an MPEG-2 TS is input, it may be demultiplexed into image, audio, and data signal, respectively. Here, the stream signal input to the demultiplexer 310 may be a stream signal output from the tuner 110, the demodulator 120, or the external apparatus interface 130.

The image processor 320 may perform image processing on a demultiplexed image signal. To this end, the image processor 320 may include an image decoder 325 and a scaler 335.

The image decoder 325 decodes a demultiplexed image signal, and the scaler 335 performs scaling so that the resolution of the decoded image signal may be output from the display 180.

The image decoder 325 may include a decoder of various standards.

The processor 330 may control overall operations within the signal processing device 170. For example, the processor 330 may control the tuner 110 to select (tune) an RF broadcast corresponding to a channel selected by the user or a pre-stored channel.

Also, the processor 330 may control the image display apparatus 100 according to a user command input through the user input interface 150 or an internal program.

Also, the processor 330 may control data transmission with the network interface 135 or the external apparatus device 130.

Also, the processor 330 may control operations of the demultiplexer 310, the image processor 320, the OSD processor 340, and the like within the signal processing device 170.

The OSD processor 340 generates an OSD signal according to a user input or by itself. For example, based on a user input signal, the OSD processor 340 may generate a signal for displaying various information as a graphic or a text on the screen of the display 180. The generated OSD signal may include various data, such as a user interface screen of the image display apparatus 100, various menu screens, a widget, and an icon. In addition, the generated OSD signal may include a 2D object or a 3D object.

In addition, the OSD processor 340 may generate a pointer that may be displayed on the display, based on a pointing signal input from the remote controller 200. In particular, such a pointer may be generated by a pointing signal processor, and the OSD processor 340 may include such a pointing signal processor (not shown). Obviously, the pointing signal processor (not shown) may be provided separately from the OSD processor 340.

The mixer 345 may mix the OSD signal generated by the OSD processing unit 340 and the decoded image signal image-processed by the image processor 320. In this case, the OSD signal and the decoded image signal may each include at least one of a 2D signal and a 3D signal. The mixed image signal is provided to the frame rate converter 350.

The frame rate converter (FRC) 350 may convert a frame rate of an input image. Meanwhile, the frame rate converter 350 may output the input image without converting the frame rate.

Meanwhile, the formatter 360 may receive a signal mixed by the mixer 345, that is, an OSD signal, and the decoded image signal, and change a format of the image signal.

Meanwhile, although not shown in the figure, it is possible to further dispose a 3D processor (not shown) for 3D effect signal processing after the formatter 360. Such a 3D processor (not shown) may process brightness, tint, and color control of an image signal to improve a 3D effect. For example, signal processing may be performed to make a short distance clear and a long distance blur. Meanwhile, the function of the 3D processor may be merged into the formatter 360 or merged into the image processor 320.

Meanwhile, the audio processor 370 in the signal processing device 170 may process a demultiplexed audio signal or an audio signal of certain content. To this end, the audio processor 370 may include various decoders.

In addition, the audio processor 370 in the signal processing device 170 may process a base, a treble, a volume control, and the like.

The data processor (not shown) in the signal processing device 170 may perform data processing of the demultiplexed data signal. For example, in case in which the demultiplexed data signal is a coded data signal, it may be decoded. The encoded data signal may be electronic program guide information including broadcast information, such as a start time and an end time of a broadcast program broadcasted on each channel.

Meanwhile, in FIG. 3, it is illustrated that signals from the OSD processor 340 and the image processor 320 are mixed in the mixer 345 and then processed in the formatter 360, but the present disclosure is not limited thereto, and the mixer may be located behind the formatter.

Meanwhile, a block diagram of the signal processing device 170 shown in FIG. 3 is a block diagram for an embodiment of the present disclosure. Each component of the block diagram may be integrated, added, or omitted according to a specification of the signal processing device 170 actually implemented.

In particular, the frame rate converter 350 and the formatter 360 may not be provided in the signal processing device 170, but may be separately provided or separately provided as a single module.

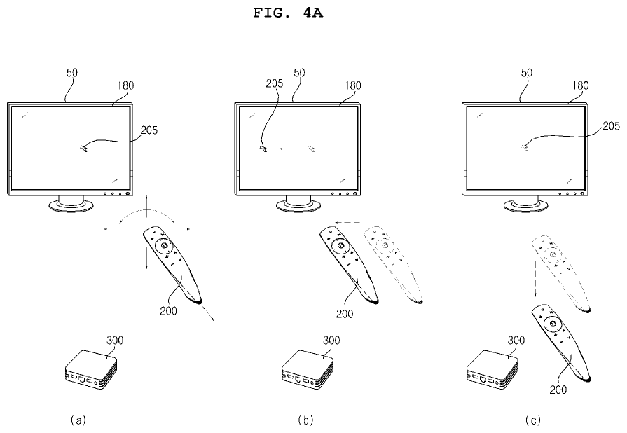

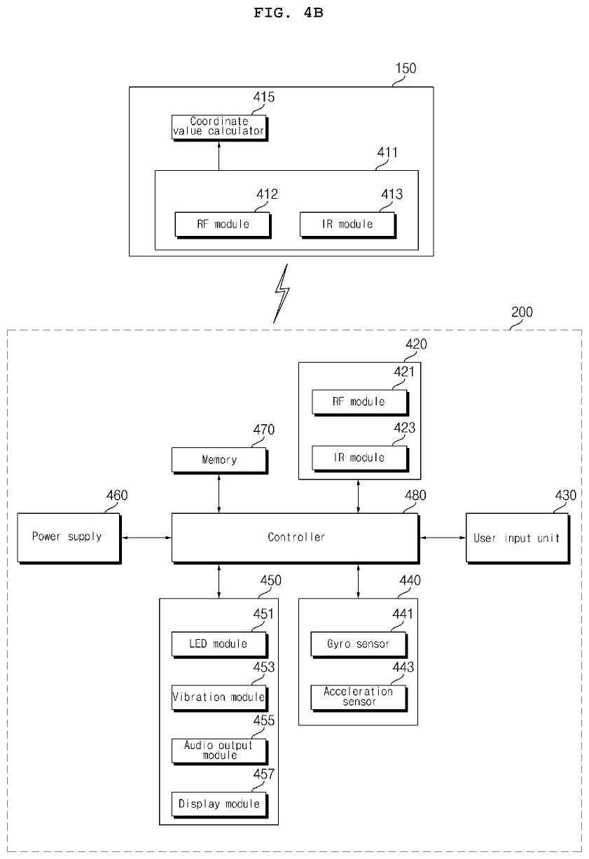

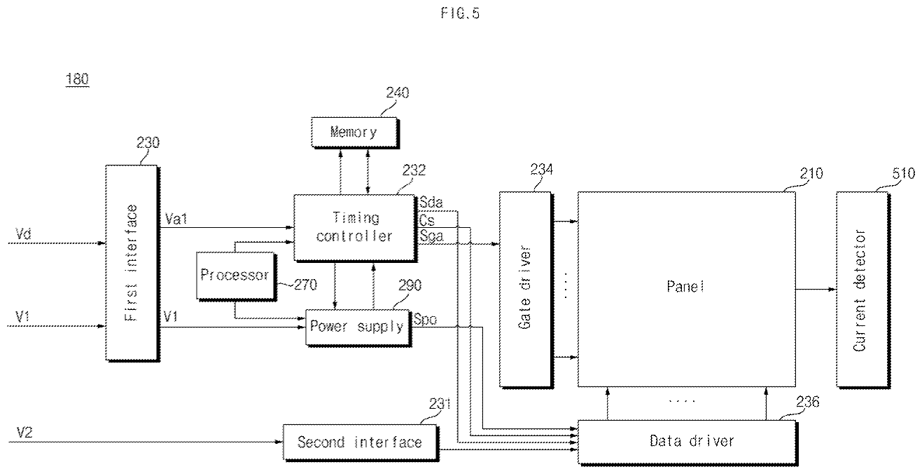

FIG. 4A is a diagram illustrating a control method of a remote controller of FIG. 2.

As shown in FIG. 4A(a), it is illustrated that a pointer 205 corresponding to the remote controller 200 is displayed on the display 180.

The user may move or rotate the remote controller 200 up and down, left and right (FIG. 4A(b)), and back and forth (FIG. 4A(c)). The pointer 205 displayed on the display 180 of the image display apparatus corresponds to the motion of the remote controller 200. Such a remote controller 200 may be referred to as a space remote controller or a 3D pointing apparatus, because the pointer 205 is moved and displayed according to the movement in a 3D space, as shown in the figure.

FIG. 4A(b) illustrates that in case in which the user moves the remote controller 200 to the left, the pointer 205 displayed on the display 180 of the image display apparatus also moves to the left correspondingly.

Information on the motion of the remote controller 200 detected through a sensor of the remote controller 200 is transmitted to the image display apparatus. The image display apparatus may calculate the coordinate of the pointer 205 from the information on the motion of the remote controller 200. The image display apparatus may display the pointer 205 to correspond to the calculated coordinate.

FIG. 4A(c) illustrates a case in which the user moves the remote controller 200 away from the display 180, while pressing a specific button of the remote controller 200. Thus, a selection region within the display 180 corresponding to the pointer 205 may be zoomed in so that it may be displayed to be enlarged. Meanwhile, in case in which the user moves the remote controller 200 close to the display 180, the selection region within the display 180 corresponding to the pointer 205 may be zoomed out so that it may be displayed to be reduced. Meanwhile, in case in which the remote controller 200 moves away from the display 180, the selection region may be zoomed out, and in case in which the remote controller 200 approaches the display 180, the selection region may be zoomed in.

Meanwhile, in case in which the specific button of the remote controller 200 is pressed, it is possible to exclude the recognition of vertical and lateral movement. That is, in case in which the remote controller 200 moves away from or approaches the display 180, the up, down, left, and right movements are not recognized, and only the forward and backward movements are recognized. Only the pointer 205 is moved according to the up, down, left, and right movements of the remote controller 200 in a state in which the specific button of the remote controller 200 is not pressed.

Meanwhile, the moving speed or the moving direction of the pointer 205 may correspond to the moving speed or the moving direction of the remote controller 200.

FIG. 4B is an internal block diagram of the remote controller of FIG. 2.

Referring to the figure, the remote controller 200 includes a wireless transceiver 425, a user input device 435, a sensor device 440, an output device 450, a power supply 460, a memory 470, and a controller 480.

The wireless transceiver 425 transmits/receives a signal to/from any one of the image display apparatuses according to the embodiments of the present disclosure described above. Among the image display apparatuses according to the embodiments of the present disclosure, one image display apparatus 100 will be described as an example.

In the present embodiment, the remote controller 200 may include an RF module 421 for transmitting and receiving signals to and from the image display apparatus 100 according to a RF communication standard. In addition, the remote controller 200 may include an IR module 423 for transmitting and receiving signals to and from the image display apparatus 100 according to a IR communication standard.

In the present embodiment, the remote controller 200 transmits a signal containing information on the motion of the remote controller 200 to the image display apparatus 100 through the RF module 421.

In addition, the remote controller 200 may receive the signal transmitted by the image display apparatus 100 through the RF module 421. In addition, if necessary, the remote controller 200 may transmit a command related to power on/off, channel change, volume change, and the like to the image display apparatus 100 through the IR module 423.

The user input device 435 may be implemented by a keypad, a button, a touch pad, a touch screen, or the like. The user may operate the user input device 435 to input a command related to the image display apparatus 100 to the remote controller 200. In case in which the user input device 435 includes a hard key button, the user may input a command related to the image display apparatus 100 to the remote controller 200 through a push operation of the hard key button. In case in which the user input device 435 includes a touch screen, the user may touch a soft key of the touch screen to input the command related to the image display apparatus 100 to the remote controller 200. In addition, the user input device 435 may include various types of input means, such as a scroll key, a jog key, etc., which may be operated by the user, and the present disclosure does not limit the scope of the present disclosure.

The sensor device 440 may include a gyro sensor 441 or an acceleration sensor 443. The gyro sensor 441 may sense information regarding the motion of the remote controller 200.

For example, the gyro sensor 441 may sense information on the operation of the remote controller 200 based on the x, y, and z axes. The acceleration sensor 443 may sense information on the moving speed of the remote controller 200. Meanwhile, a distance measuring sensor may be further provided, and thus, the distance to the display 180 may be sensed.

The output device 450 may output an image or an audio signal corresponding to the operation of the user input device 435 or a signal transmitted from the image display apparatus 100. Through the output device 450, the user may recognize whether the user input device 435 is operated or whether the image display apparatus 100 is controlled.

For example, the output device 450 may include an LED module 451 that is turned on in case in which the user input device 435 is operated or a signal is transmitted/received to/from the image display apparatus 100 through the wireless transceiver 425, a vibration module 453 for generating a vibration, an audio output module 455 for outputting an audio, or a display 457 for outputting an image.

The power supply 460 supplies power to the remote controller 200. In case in which the remote controller 200 is not moved for a certain time, the power supply 460 may stop the supply of power to reduce a power waste. The power supply 460 may resume power supply in case in which a certain key provided in the remote controller 200 is operated.

The memory 470 may store various types of programs, application data, and the like necessary for the control or operation of the remote controller 200. If the remote controller 200 wirelessly transmits and receives a signal to/from the image display apparatus 100 through the RF module 421, the remote controller 200 and the image display apparatus 100 transmit and receive a signal through a certain frequency band. The controller 480 of the remote controller 200 may store information regarding a frequency band or the like for wirelessly transmitting and receiving a signal to/from the image display apparatus 100 paired with the remote controller 200 in the memory 470 and may refer to the stored information.

The controller 480 controls various matters related to the control of the remote controller 200. The controller 480 may transmit a signal corresponding to a certain key operation of the user input device 435 or a signal corresponding to the motion of the remote controller 200 sensed by the sensor device 440 to the image display apparatus 100 through the wireless transceiver 425.

The user input interface 150 of the image display apparatus 100 includes a wireless transceiver 151 that may wirelessly transmit and receive a signal to and from the remote controller 200 and a coordinate value calculator 415 that may calculate the coordinate value of a pointer corresponding to the operation of the remote controller 200.

The user input interface 150 may wirelessly transmit and receive a signal to and from the remote controller 200 through the RF module 412. In addition, the user input interface 150 may receive a signal transmitted by the remote controller 200 through the IR module 413 according to a IR communication standard.

The coordinate value calculator 415 may correct a hand shake or an error from a signal corresponding to the operation of the remote controller 200 received through the wireless transceiver 151 and calculate the coordinate value (x, y) of the pointer 205 to be displayed on the display 180.

The transmission signal of the remote controller 200 inputted to the image display apparatus 100 through the user input interface 150 is transmitted to the controller 180 of the image display apparatus 100. The controller 180 may determine the information on the operation of the remote controller 200 and the key operation from the signal transmitted from the remote controller 200, and, correspondingly, control the image display apparatus 100.

For another example, the remote controller 200 may calculate the pointer coordinate value corresponding to the operation and output it to the user input interface 150 of the image display apparatus 100. In this case, the user input interface 150 of the image display apparatus 100 may transmit information on the received pointer coordinate value to the controller 180 without a separate correction process of hand shake or error.

For another example, unlike the figure, the coordinate value calculator 415 may be provided in the signal processing device 170, not in the user input interface 150.

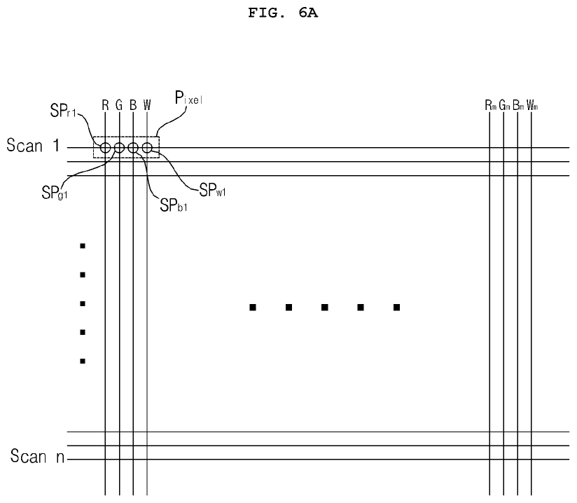

FIG. 5 is an internal block diagram of a display of FIG. 2.

Referring to FIG. 5, the display 180 may include an organic light emitting diode panel 210, a first interface 230, a second interface 231, a timing controller 232, a gate driver 234, a data driver 236, a memory 240, a processor 270, a power supply 290, a current detector 510, and the like.

The display 180 receives an image signal Vd, a first DC power V1, and a second DC power V2, and may display a certain image based on the image signal Vd.

Meanwhile, the first interface 230 in the display 180 may receive the image signal Vd and the first DC power V1 from the signal processing device 170.

Here, the first DC power V1 may be used for the operation of the power supply 290 and the timing controller 232 in the display 180.

Next, the second interface 231 may receive a second DC power V2 from an external power supply 190. Meanwhile, the second DC power V2 may be input to the data driver 236 in the display 180.

The timing controller 232 may output a data driving signal Sda and a gate driving signal Sga, based on the image signal Vd.

For example, in case in which the first interface 230 converts the input image signal Vd and outputs the converted image signal val, the timing controller 232 may output the data driving signal Sda and the gate driving signal Sga based on the converted image signal val.

The timing controller 232 may further receive a control signal, a vertical synchronization signal Vsync, and the like, in addition to the image signal Vd from the signal processing device 170.

In addition to the image signal Vd, based on a control signal, a vertical synchronization signal Vsync, and the like, the timing controller 232 generates a gate driving signal Sga for the operation of the gate driver 234, and a data driving signal Sda for the operation of the data driver 236.

At this time, in case in which the panel 210 includes a RGBW subpixel, the data driving signal Sda may be a data driving signal for driving of RGBW subpixel.

Meanwhile, the timing controller 232 may further output a control signal Cs to the gate driver 234.

The gate driver 234 and the data driver 236 supply a scan signal and an image signal to the organic light emitting diode panel 210 through a gate line GL and a data line DL respectively, according to the gate driving signal Sga and the data driving signal Sda from the timing controller 232. Accordingly, the organic light emitting diode panel 210 displays a certain image.

Meanwhile, the organic light emitting diode panel 210 may include an organic light emitting layer. In order to display an image, a plurality of gate lines GL and data lines DL may be disposed in a matrix form in each pixel corresponding to the organic light emitting layer.

Meanwhile, the data driver 236 may output a data signal to the organic light emitting diode panel 210 based on a second DC power V2 from the second interface 231.

The power supply 290 may supply various power supplies to the gate driver 234, the data driver 236, the timing controller 232, and the like.

The current detector 510 may detect the current flowing in a sub-pixel of the organic light emitting diode panel 210. The detected current may be input to the processor 270 or the like, for a cumulative current calculation.

The processor 270 may perform each type of control of the display 180. For example, the processor 270 may control the gate driver 234, the data driver 236, the timing controller 232, and the like.

Meanwhile, the processor 270 may receive current information flowing in a sub-pixel of the organic light emitting diode panel 210 from the current detector 510.

In addition, the processor 270 may calculate the accumulated current of each subpixel of the organic light emitting diode panel 210, based on information of current flowing through the subpixel of the organic light emitting diode panel 210. The calculated accumulated current may be stored in the memory 240.

Meanwhile, the processor 270 may determine as burn-in, if the accumulated current of each sub-pixel of the organic light emitting diode panel 210 is equal to or greater than an allowable value.

For example, if the accumulated current of each subpixel of the OLED panel 210 is equal to or higher than 300000 A, the processor 270 may determine that a corresponding subpixel is a burn-in subpixel.

Meanwhile, if the accumulated current of each subpixel of the OLED panel 210 is close to an allowable value, the processor 270 may determine that a corresponding subpixel is a subpixel expected to be burn in.

Meanwhile, based on a current detected by the current detector 510, the processor 270 may determine that a subpixel having the greatest accumulated current is an expected burn-in subpixel.

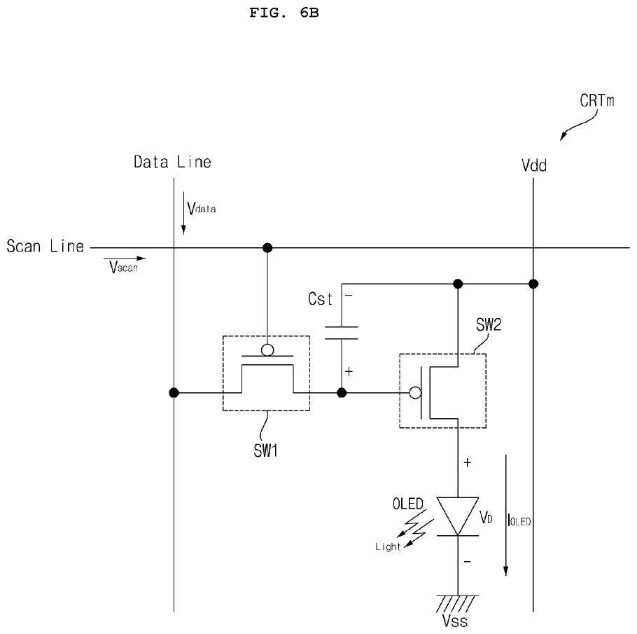

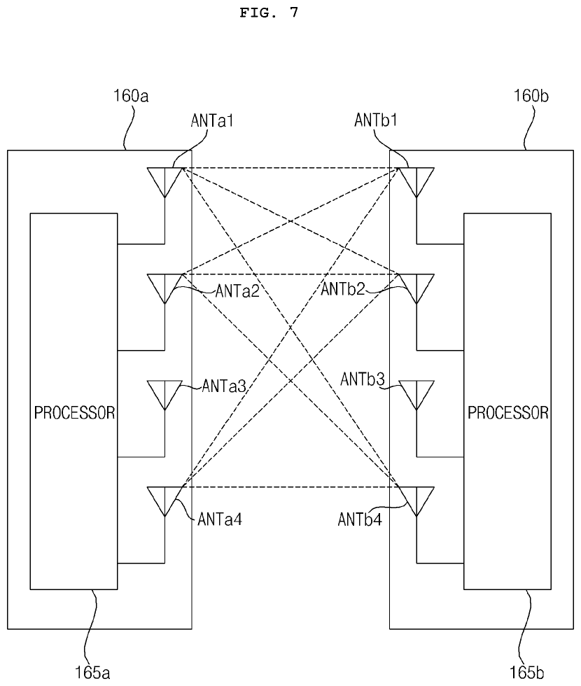

FIG. 6A and FIG. 6B are diagrams referred to in the description of an organic light emitting diode panel of FIG. 5.

Firstly, FIG. 6A is a diagram illustrating a pixel in the organic light emitting diode panel 210.

Referring to the figure, the organic light emitting diode panel 210 may include a plurality of scan lines Scan1 to Scann and a plurality of data lines R1, G1, B1, W1 to Rm, Gm, Bm, Wm intersecting the scan lines.

Meanwhile, a pixel (subpixel) is defined in an intersecting region of the scan line and the data line in the organic light emitting diode panel 210. In the figure, a pixel including sub-pixels SR1, SG1, SB1 and SW1 of RGBW is shown.

FIG. 6B illustrates a circuit of any one sub-pixel in the pixel of the organic light emitting diode panel of FIG. 6A.

Referring to the figure, an organic light emitting sub pixel circuit (CRTm) may include, as an active type, a scan switching element SW1, a storage capacitor Cst, a drive switching element SW2, and an organic light emitting layer (OLED).

The scan switching element SW1 is turned on according to the input scan signal Vdscan, as a scan line is connected to a gate terminal. In case in which it is turned on, the input data signal Vdata is transferred to the gate terminal of a drive switching element SW2 or one end of the storage capacitor Cst.

The storage capacitor Cst is formed between the gate terminal and the source terminal of the drive switching element SW2, and stores a certain difference between a data signal level transmitted to one end of the storage capacitor Cst and a DC power (VDD) level transmitted to the other terminal of the storage capacitor Cst.

For example, in case in which the data signal has a different level according to a Plume Amplitude Modulation (PAM) method, the power level stored in the storage capacitor Cst varies according to the level difference of the data signal Vdata.

For another example, in case in which the data signal has a different pulse width according to a pulse width modulation (PWM) method, the power level stored in the storage capacitor Cst varies according to the pulse width difference of the data signal Vdata.

The drive switching element SW2 is turned on according to the power level stored in the storage capacitor Cst. In case in which the drive switching element SW2 is turned on, the driving current (IOLED), which is proportional to the stored power level, flows in the organic light emitting layer (OLED). Accordingly, the organic light emitting layer OLED performs a light emitting operation.

The organic light emitting layer OLED may include a light emitting layer (EML) of RGBW corresponding to a subpixel, and may include at least one of a hole injecting layer (HIL), a hole transporting layer (HTL), an electron transporting layer (ETL), and an electron injecting layer (EIL). In addition, it may include a hole blocking layer, and the like.

Meanwhile, the subpixels emit a white light in the organic light emitting layer OLED. However, in the case of green, red, and blue subpixels, a subpixel is provided with a separate color filter for color implementation. That is, in the case of green, red, and blue subpixels, each of the subpixels further includes green, red, and blue color filters. Meanwhile, since a white subpixel outputs a white light, a separate color filter is not required.

Meanwhile, in the figure, it is illustrated that a p-type MOSFET is used for a scan switching element SW1 and a drive switching element SW2, but an n-type MOSFET or other switching element, such as a JFET, IGBT, SIC, or the like are also available.

Meanwhile, the pixel is a hold-type element that continuously emits light in the organic light emitting layer (OLED), after a scan signal is applied, during a unit display period, specifically, during a unit frame.

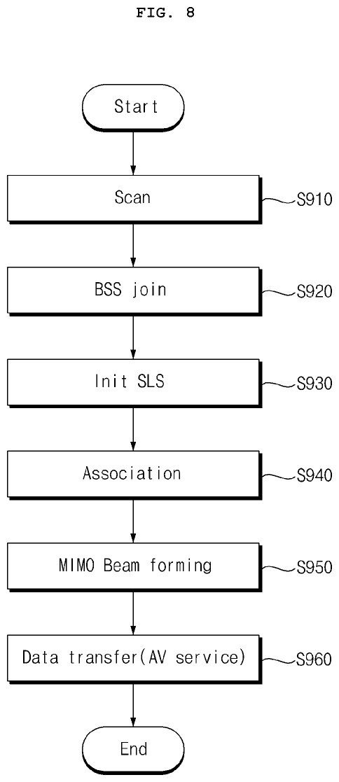

FIG. 7 is a diagram referred to in the description of a transceiver device of FIG. 2 and a second transceiver device.

Referring to the figure, the transceiver device 160a may include 2*2-based multiple-input and multiple-output (MIMO) antennas ANTa1 to ANTa4 and a processor 165a.

The transceiver device 160a may output beams for each sector based on the 2*2-based MIMO antennas ANTa1 to ANTa4.

The transceiver device 160a may perform wireless communication based on the 802.11 ad/ay standard. Accordingly, media data may be stably transmitted wirelessly.

The processor 165a may perform control to transmit a first signal based on a beam having a first shape in which a sector is sequentially varied during a first period, receive a second signal based on a beam having the first shape from the display device 50 during a third period according to selection of the wireless media device 300 of the display device 50 during a second period, approve association with the display device 50 based on network address information in the second signal during a fourth period, transmit a third signal based on a beam having a second shape at an angle smaller than that of the first shape during a fifth period, and transmit wireless media to the display device 50 based on a beam having the second shape during a sixth period.

Meanwhile, the second transceiver device 160b may include a 2*2-based MIMO antennas ANTb1 to ANTb4 and a second processor 165b.

The second transceiver device 160b may output beams for each sector based on the 2*2-based MIMO antennas ANTb1 to ANTb4.

The second transceiver device 160b may perform wireless communication based on the 802.11 ad/ay standard.

The second processor 165b may perform control to receive the first signal based on the beam having the first shape in which a sector is sequentially varied during the first period, select the wireless media device 300 based on the first signal during the second period, transmit the second signal based on the beam having the first shape including network address information during the third period, approve association with the wireless media device 300 during the fourth period, receive the third signal based on the beam having the second shape at an angle smaller than that of the first shape during the fifth period, and display an image on the display based on reception of wireless media based on the beam having the second shape during the sixth period.

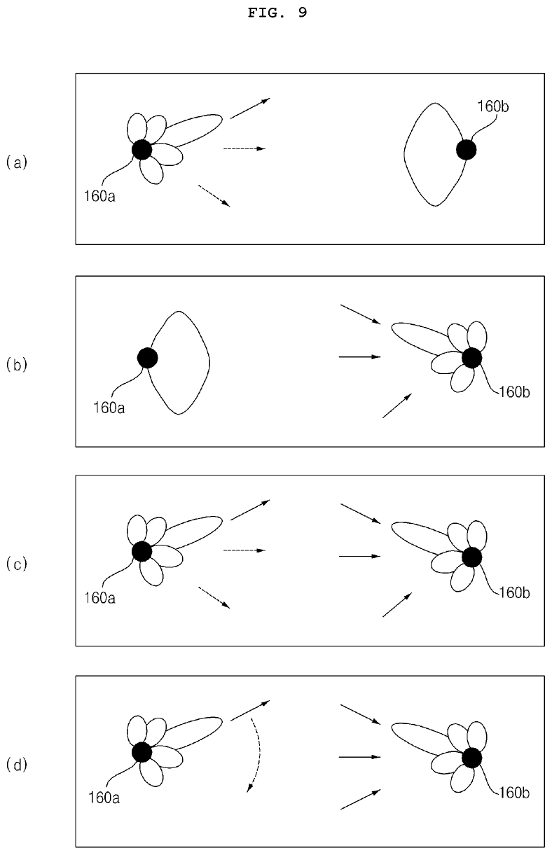

FIG. 8 is a flowchart illustrating an operation of an image display apparatus.

Referring to the figure, during the first period (S910), the transceiver device 160a in the wireless media device 300 of the image display apparatus 100 transmits the first signal based on the beam having first shape in which a sector is sequentially varied. Meanwhile, the first period S910 may be referred to as a scan period.

During the second period (S920), the second transceiver device 160b in the display device 50 of the image display apparatus 100 selects one beam from among a plurality of received beams. Meanwhile, the second period (S920) may be referred to as a basic service set (BSS) join period.

For example, during the second period (S920), the second transceiver device 160b in the display device 50 may select a beam output from the wireless media device 300, rather than other wireless media devices.

Meanwhile, during the second period (S920), the second transceiver device 160b in the display device 50 may extract a beacon signal in the first signal based on the beam having the first shape and roughly recognize position information of the wireless media device 300 based on the beacon signal.

Also, the second transceiver device 160b in the display device 50 transmits the second signal based on the beam having the first shape. The second signal here may include information related to the second transceiver device 160b. For example, the second signal may include sector information.

During the third period (S930) after the second period (S920), the transceiver device 160a within the wireless media device 300 receives the second signal based on the beam having the first shape from the display device 50. Meanwhile, the third period S930 may be referred to as a sector level sweep (SLS) period.

Meanwhile, during the third period (S930), the transceiver device 160a in the wireless media device 300 may select any one of a plurality of sectors.

For example, during the third period (S930), the transceiver device 160a in the wireless media device 300 may select any one of the plurality of sectors based on sector information in the second signal.

During the fourth period (S940) after the third period (S930), the transceiver device 160a in the wireless media device 300 approves association with the display device 50 based on the network address information (e.g., MAC address information) in the second signal. The fourth period (S940) may be referred to as an association period.

Meanwhile, during the fourth period (S940), the transceiver device 160a in the wireless media device 300 may approve the association with the display device 50 based on the network address information and communication available channel information in the second signal.

During the fifth period (S950) after the fourth period (S940), the transceiver device 160a in the wireless media device 300 transmits the third signal based on the beam having the second shape at an angle smaller than that of the first shape. The fifth period (S950) may be referred to as a MIMO beamforming period.

During the fifth period (S950), the transceiver device 160a in the wireless media device 300 may select any one of a plurality of beams within the selected sector.

Also, during the fifth period (S950), the transceiver device 160a in the wireless media device 300 may output the beam having the second shape having a beam width narrower than the first shape based on the selected sector.

During the sixth period (S960) after the fifth period (S950), wireless media is transmitted to the display device 50 based on the beam having the second shape. The sixth period (S960) may be referred to as a data transfer period.

Meanwhile, the transceiver device 160a in the wireless media device 300 may determine whether an error occurs during wireless media transmission, and in case in which an error does not occur, the transceiver device 160a in the wireless media device 300 may control the sixth period (S960) to be continuously performed, and in case in which an error occurs, the transceiver device 160a in the wireless media device 300 may control the fifth period and the sixth period (S950 and S960) to be performed again, control the third period to the sixth period (S930 to S960) to be performed again, or control the first period to the sixth period (S930 to S960) to be performed again, selectively, depending on an error range. Accordingly, the error may be efficiently recovered depending on the error range.

Meanwhile, in case in which wireless media is received, the second transceiver device 160b may control the fifth period and the sixth period (S950 and S960) to be performed again, control the third period to the sixth period (S930 to S960) to be performed again, or control the first period to the sixth period (S910 to S960) to be performed again, selectively, depending on an error range. Accordingly, an error may be efficiently recovered depending on the error range.

FIG. 9 is a view referred to in the description of FIG. 8.

Referring to the figure, FIG. 9 is a diagram illustrating a beamforming process.

First, (a) of FIG. 9 illustrates that, as in step 910 (S910), a beam having a first shape in which a sector is sequentially varied is output from the transceiver device 160a. At this time, the second transceiver device 160b may perform scanning.

(b) of FIG. 9 illustrates receiving of a plurality of beams by the second transceiver device 160b.

(c) of FIG. 9 illustrates that a beam corresponding to any one sector among a plurality of beams is output from the transceiver device 160a. In response to this, the second transceiver device 160b receives the beam of the corresponding sector.

(d) of FIG. 9 illustrates that the second transceiver device 160b performs beam tracking. The second transceiver device 160b may select any one of a plurality of received beams based on beam strength and the like.

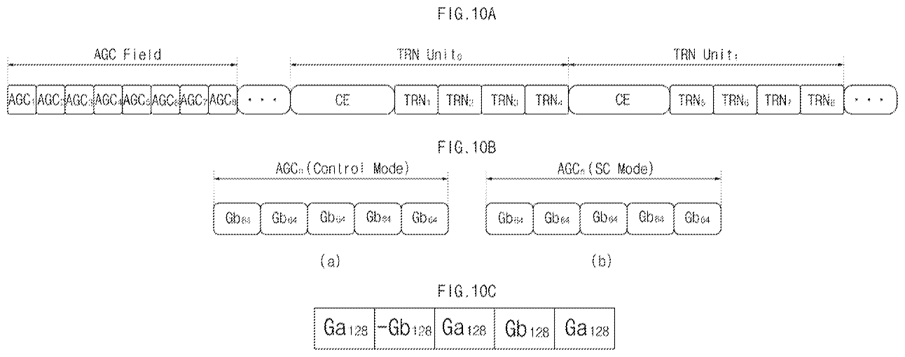

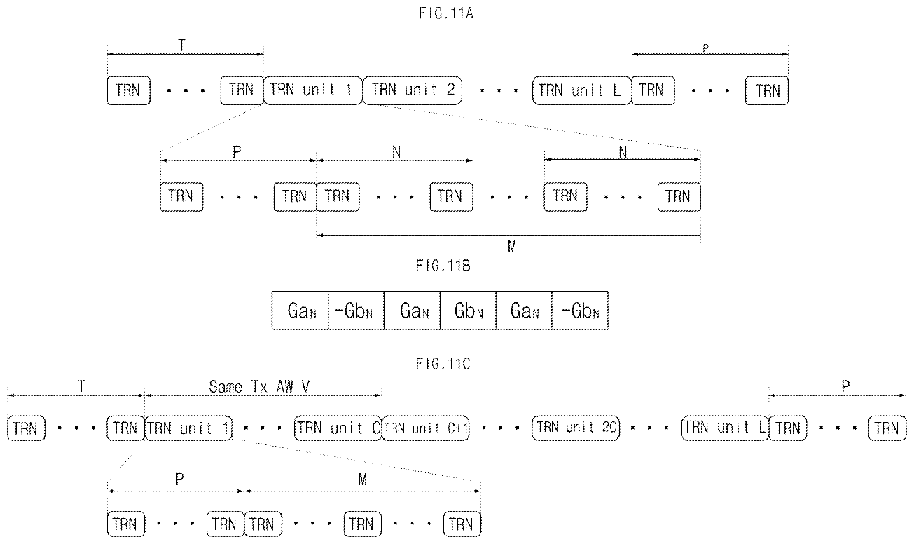

FIGS. 10A to 12C are diagrams referred to in the description of an operation of a wireless media device related to the present disclosure.

FIG. 10A is a diagram illustrating an example of a structure of a training field for beam training.

Referring to the figure, a training field based on the 802.11ad standard may include an automatic gain control (AGC) field and a plurality of training units TRN Unit0, TRN Unit1, . . . .

Meanwhile, the AGC field may include a plurality of pieces of AGC information AGC1 to AGC8.

Meanwhile, a first training unit TRN Unit0 may include channel estimation information CE and a plurality of pieces of TRN information TRN1 to TRN4, and the second training unit TRN Unit1 may include channel estimation information CE and a plurality of pieces of TRN information TRN5 to TRN8.

FIG. 10B illustrates an internal structure of the AGC information of FIG. 10A.

Referring to the figure, AGC information may be classified into AGC information for a control mode and AGC information for a single carrier (SC) mode.

Meanwhile, the AGC information for a control mode and the AGC information for an SC mode may each include five Ga64 sequences.

FIG. 10C illustrates an internal structure of the channel estimation information CE of FIG. 10A.

Referring to the figure, the channel estimation information CE may include 5 Golay sequences for channel estimation.

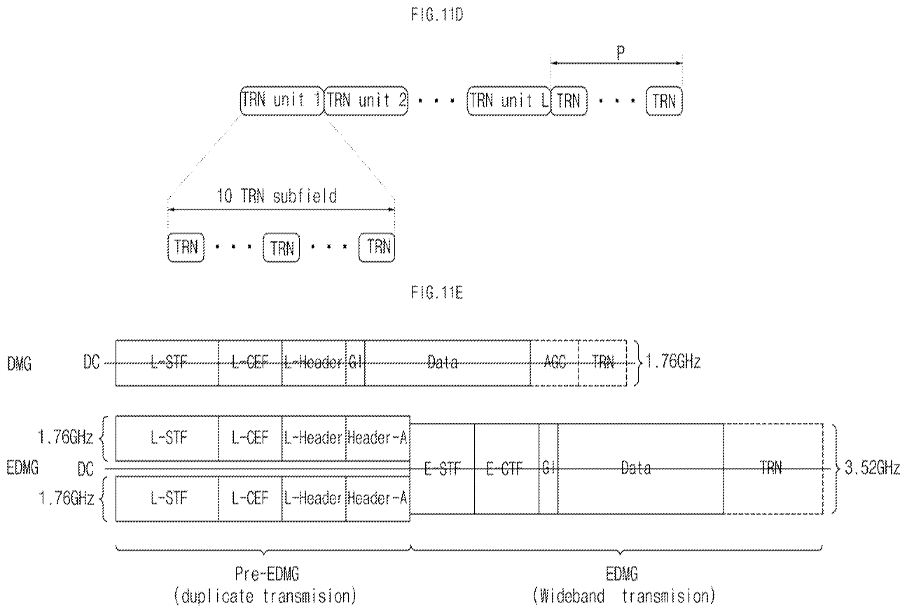

FIG. 11A is a diagram illustrating another example of a structure of a training field for beam training.

Referring to the figure, a training field based on the 802.11ay standard includes T training subfields TRN, a plurality of training units TRN Unit1 to TRN UnitL, and P training subfields TRN.

The T training subfields TRN are fields for a transition time and do not perform any operation.

Meanwhile, among the plurality of training units TRN Unit1 to TRN UnitL, a first training unit TRN Unit1 may include N training subfields TRN.

Meanwhile, different transmit AWV indices may be used for N training subfields TRN, respectively.

Meanwhile, AGC may operate each time the AWV index changes.

Meanwhile, the P training subfields TRN may perform the same role as that of the channel estimation information CE of FIGS. 10A to 10C.

FIG. 11B illustrates an internal structure of the training subfield TRN of FIG. 11A.

Referring to the figure, the training subfield TRN may include 6 Golay sequences.

11C is a diagram illustrating another example of a structure of a training field for beam training.

Referring to the figure, the training field based on the 802.11ay standard may include T training subfields TRN, a plurality of training units TRN Unit1 to TRN UnitL, and P training subfields TRN.

The T training subfields TRN are fields for a transition time and do not perform any operation.

Meanwhile, among the plurality of training units TRN Unit1 to TRN UnitL, the first training unit TRN Unit1 may include P training subfields TRN and N training subfields TRN.

Meanwhile, the same Transmit AWV index is applied to C training units TRN Unit1 to TRN UnitC among the plurality of training units TRN Unit1 to TRN UnitL.

Meanwhile, the P training subfields TRN may perform the same role as that of the channel estimation information CE of FIGS. 10A to 10C.

Meanwhile, it may be received while changing the Receive AWV index within C×M training subfields TRNs.

FIG. 11D is a diagram illustrating another example of a structure of a training field for beam training.

Referring to the figure, a training field based on the 802.11ay standard may include L training units TRN Unit1 to TRN UnitL and P training subfields TRN.

Among the plurality of training units TRN Unit1 to TRN UnitL, a first training unit TRN Unit1 may include 10 training subfields.

Meanwhile, in the plurality of training units TRN Unit1 to TRN UnitL, the same Transmit AWV index may be applied, and the P training subfields TRN play the same role as that of the channel estimation information CE of FIGS. 10A to 10C.

Meanwhile, it may be received while changing the Receive AWV index within 10×L training subfields TRN.

FIG. 11E illustrates a frame structure for transmission of a PHY protocol data unit (PPDU) in a single mode.

Referring to the figure, a data frame DMG based on the an 802.11ad may include a legacy-short training field (L-STF) corresponding to training information, a legacy-channel estimation field (L-CEF) corresponding to channel estimation information, legacy-header (L-header), data, AGC, and training subfield TRN.

A data frame EDMG based on the 802.11ad may include L-STF corresponding to training information, L-CEF corresponding to channel estimation information, L-header, Header-A, and EDMG-short training field (E-STF) corresponding to training information, an EDMG-channel estimation field (E-CEF) corresponding to channel estimation information, data, and a training subfield TRN.

Meanwhile, among data frames (EDMG) based on the 802.11ay, the L-STF, L-CEF, L-CEF, L-header, and Header-Asms may be used for duplicate transmission, and E-CEF, data, the training subfield TRN may be used for wideband transmission.

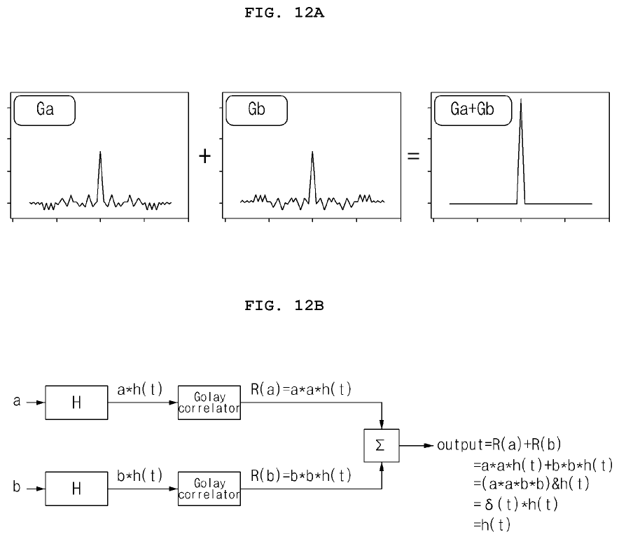

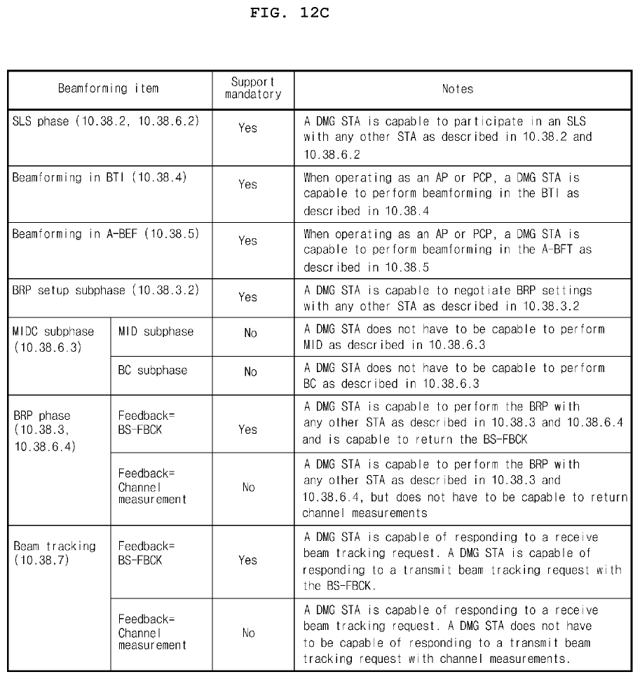

FIGS. 12A and 12B are diagrams illustrating channel estimation using a Golay sequence.

FIG. 12A illustrates the sum of a first pattern Ga and a second pattern Gb of the Golay sequence.

FIG. 12B illustrates an operation using a transfer function H and a Golay correlator for the first pattern Ga and the second pattern Gb, respectively, and summing an operation result using an adder.

FIG. 12C is a diagram illustrating a beamforming procedure.

Referring to the figure, an SLS phase is related to sector level sweep and performs beam training on a region divided into large zones. Meanwhile, (a) of FIG. 9 may correspond to the SLS phase.

Beamforming in BTI performs beam training on an initiator, such as a PCP (e.g., the wireless media device 300).

Beamforming in A-BFT performs beam training on a responder (e.g., the display device 50), such as NPCP.

A BRP setup subphase exchanges beam refinement capability information and requests execution of a BRP subphase.

An MIDC subphase may include an MID subphase and a BC subphase.

In an MID subphase, a quasi-omni transmission pattern is tested for a plurality of receive AWVs, and in a BC subphase, a set of transmit AWV and receive AWV are tested in combination.

Meanwhile, (b) of FIG. 9 may correspond to the MID subphase, and (c) of FIG. 9 may correspond to the BC subphase.

A BRP phase may include BS-FBCK and channel measurement.

Beam refinement is a request/response-based process, and additional transmit beam/receive beam training may be requested by PCP/NPCP.

Beam tracking may include BS-FBCK and channel measurement.

Beam tracking may be performed in a data transfer interval (DTI).

Meanwhile, the initiator (e.g., the wireless media device 300) may request beam tracking for an initiator (e.g., the wireless media device 300) or a responder (e.g., the display device 50).

Meanwhile, (d) of FIG. 9 may correspond to a BRP phase or beam tracking.

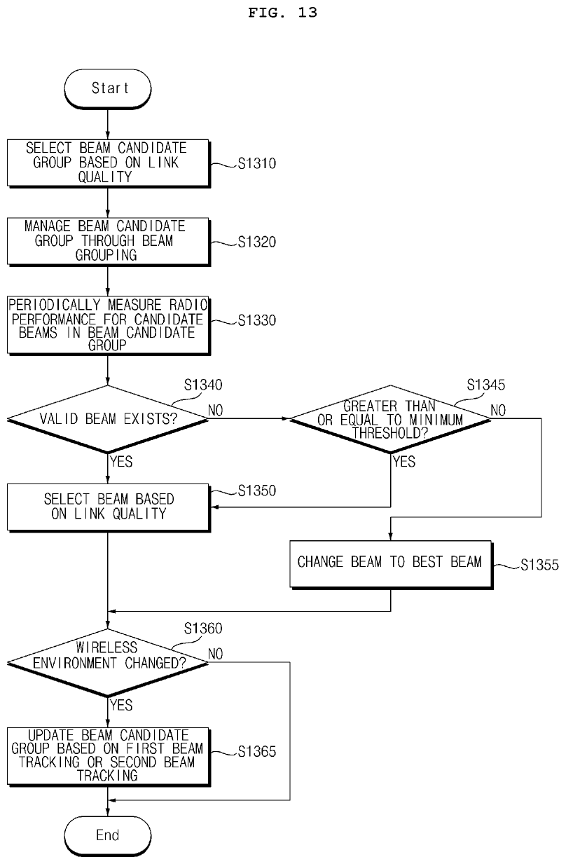

FIG. 13 is a flowchart illustrating an operation of a wireless media device according to an embodiment of the present disclosure.

Referring to the figure, the transceiver device 160a in the wireless media device 300 according to an embodiment of the present disclosure selects a beam candidate group based on measured link quality between the wireless media device 300 and the display device 50 (S1310).

The transceiver device 160a may transmit a plurality of beams in different directions according to transmission angles.

At this time, the transceiver device 160a may select the beam candidate group based on the measured link quality.

Meanwhile, the transceiver device 160a may identify a plurality of regions for a beam candidate group, select candidate beams from some of the plurality of regions, and manage the same.

Meanwhile, the transceiver device 160a may select a first number of beams as candidates in a first region to which a first beam belongs among the plurality of regions, select a second number of beams as candidates in a second region adjacent to the first region in a first direction, among the plurality of regions, and select a third number of beams as candidates in a third region adjacent to the first region in a second direction, among the plurality of regions.

Meanwhile, the first region may be a region in which a beam having the highest link quality exists.

Alternatively, the first region may be a region corresponding to an LOS path.

Meanwhile, the second region may be a region disposed in a vertical direction of the first region, and the third region may be a region disposed in a horizontal direction of the first region.

Meanwhile, in case in which selecting a plurality of candidate beams in a plurality of regions, the transceiver device 160a may select different numbers of candidate beams in the first to third regions.

For example, the transceiver device 160a may select candidate beams such that the second number is greater than the first number and the second number is greater than the third number.

As another example, the transceiver device 160a may select candidate beams such that the third number is greater than the first number.

Meanwhile, since the first region mostly corresponds to a front direction, the transceiver device 160a may select only one best beam in the first region as a candidate beam.

Meanwhile, the transceiver device 160a may select about 6 beams as candidate beams in consideration of a possibility that the second region is selected by a side robe.

Meanwhile, since there is a possibility that the third region does not exist compared to the second region, the transceiver device 160a may select about four beams as candidate beams.

Meanwhile, the plurality of regions may further include a fourth region in which candidate beams are not selected.

Meanwhile, since a probability that a good beam exists in the fourth region is low, the transceiver device 160a may not select a candidate beam.

Next, the transceiver device 160a manages a beam candidate group through beam grouping (S1320).

The transceiver device 160a may identify a plurality of regions for a beam candidate group, select candidate beams from some of the plurality of regions, and manage the selected candidate beams.

For example, the transceiver device 160a may identify the first to fourth regions for a beam candidate group, select candidate beams from the first to third regions among the first to fourth regions, and manage the same.

Next, the transceiver device 160a measures radio performance or link quality of the candidate beams in the beam candidate group periodically or upon request (S1330).

Next, the transceiver device 160a determines whether a valid beam exists based on the measured radio performance or link quality (S1340), and if a valid beam exists, the transceiver device 160a selects the beam based on the measured link quality (S1350).

For example, the transceiver device 160a may determine whether the candidate beams in the beam candidate group are valid beams based on measured radio performance or link quality.

Meanwhile, the transceiver device 160a may classify the candidate beams in the beam candidate group into valid beams and invalid beams based on the measured radio performance or link quality and manage the same.

Meanwhile, in case in which there are valid beams among the candidate beams in the beam candidate group, the transceiver device 160a may select a beam having the best link quality among the valid beams.

Meanwhile, in case in which a beam having a predetermined link quality or higher exists in a state in which the current beam is a valid beam, the transceiver device 160a may change the beam.

Accordingly, it is possible to prevent a phenomenon in which a beam change is repeated in case in which there is a fluctuation in the measured link quality.

Meanwhile, in step 1340 (S1340), if there is no valid beam, it is determined whether the measured link quality is greater than or equal to a minimum threshold (step S1345), and if it is determined that the measured link quality is greater than or equal to the minimum threshold, step 1350 is performed to select a beam based on the measured link quality.

That is, the transceiver device 160a may select a candidate beam having the highest measured link quality from the beam candidate group in case in which there is no valid beam and the measured link quality is equal to or greater than a minimum threshold. Accordingly, the link may be maintained.

Meanwhile, in step S1345, in case in which the measured link quality is less than the minimum threshold, the transceiver device 160a may perform beam selection based on the best beam (S1355).

That is, the transceiver device 160a may perform beam selection based on the best beam in case in which there is no valid beam and the measured link quality of a plurality of candidate beams in the beam candidate group is less than the minimum threshold.

For example, if the link quality of all of the plurality of candidate beams in the candidate group is less than a minimum threshold, beam changing is meaningless, so the transceiver device 160a may change the beam to the best beam having a high probability of being an LOS path.

Meanwhile, in a state in which the valid beam is changed to the invalid beam, in case in which the link quality of the invalid beam is measured to have a level of the valid beam, the transceiver device 160a controls updating to the valid beam after a certain period of time, rather than immediately updating to the valid beam.

Accordingly, it is possible to filter a case of switching to a valid beam only momentarily, and eventually, stable management and update of a valid beam are possible.

Next, the transceiver device 160a determines whether the wireless environment changes (S1360), and in case in which the wireless environment changes, the transceiver device 160a may update the beam candidate group based on first beam tracking performed during a first period and second beam tracking performed during a second period longer than the first period (S1365).

That is, the transceiver device 160a may update the beam candidate group based on the first beam tracking performed during the first period based on the wireless environment between the wireless media device 300 and the display device 50 or the second period longer than the first period.

For example, in case in which the change in the wireless environment is within a first range, the transceiver device 160a may control to perform first beam tracking during the first period, and in case in which the change in the wireless environment is within a second range greater than the first range, the transceiver device 160a may control to perform the second beam tracking during the second period longer than the first period.

Meanwhile, in case in which performing the first beam tracking, the transceiver device 160a may perform beam tracking based on a plurality of candidate beams in the beam candidate group.

Meanwhile, in case in which performing second beam tracking, the transceiver device 160a may update the beam candidate group by measuring the link quality of the beam candidate group and beams other than the beam candidate group. Accordingly, beam tracking can be efficiently performed. Furthermore, beam tracking can be efficiently performed depending on the wireless environment.

Meanwhile, the transceiver device 160a may add the best beam selected based on the second beam tracking, the currently used beam, and the previous best beam into the beam candidate group and manage the same. Accordingly, it is possible to prepare for a case in which an incorrect beam is selected as the best beam due to a temporary change in the wireless environment.

Meanwhile, the operation of the wireless media device 300 described above with reference to FIG. 13 may be applied to the operation of the display device 50 as it is.

The second transceiver device 160b in the display device 50 according to an embodiment of the present disclosure may select a beam candidate group based on the measured link quality between the wireless media device 300 and the display device 50.

The second transceiver device 160b in the display device 50 may transmit a plurality of beams in different directions according to transmission angles.

At this time, the second transceiver device 160b within the display device 50 may select a beam candidate group based on the measured link quality.

Meanwhile, the second transceiver device 160b in the display device 50 may identify a plurality of regions for the beam candidate group, select candidate beams from some of the plurality of regions and manage the same.

Meanwhile, the second transceiver device 160b in the display device 50 may select a first number of beams as candidates in a first region to which a first beam belongs among the plurality of regions, select a second number of beams as candidates in a second region adjacent to the first region in a first direction, among the plurality of regions, and select a third number of beams as candidates in a third region adjacent to the first region in a second direction, among the plurality of regions.

Meanwhile, in case in which selecting a plurality of candidate beams in a plurality of regions, the second transceiver device 160b in the display device 50 may select different numbers of candidate beams in the first to third regions.

For example, the second transceiver device 160b in the display device 50 may select candidate beams such that the second number is greater than the first number and the second number is greater than the third number.

As another example, the second transceiver device 160b in the display device 50 may select candidate beams such that the third number is greater than the first number.

Meanwhile, since the first region mostly corresponds to a front direction, the transceiver device 160b in the display device 50 may select only one best beam in the first region as a candidate beam.

Meanwhile, the transceiver device 160b in the display device 50 may select about 6 beams as candidate beams in consideration of a possibility that the second region is selected by a side robe.

Meanwhile, since there is a possibility that the third region does not exist compared to the second region, the transceiver device 160b in the display device 50 may select about four beams as candidate beams.

Meanwhile, since a probability that a good beam exists in the fourth region is low, the transceiver device 160b in the display device 50 may not select a candidate beam.

Next, the transceiver device 160b in the display device 50 may manage a beam candidate group through beam grouping.

The transceiver device 160b in the display device 50 may identify a plurality of regions for a beam candidate group, select candidate beams from some of the plurality of regions, and manage the selected candidate beams.

For example, the transceiver device 160b in the display device 50 may identify the first to fourth regions for a beam candidate group, select candidate beams from the first to third regions among the first to fourth regions, and manage the same.

Next, the transceiver device 160b in the display device 50 may measure radio performance or link quality of the candidate beams in the beam candidate group periodically or upon request.

Next, the transceiver device 160b in the display device 50 determines whether a valid beam exists based on the measured radio performance or link quality, and if a valid beam exists, the transceiver device 160b in the display device 50 may select the beam based on the measured link quality.

For example, the transceiver device 160b in the display device 50 may determine whether the candidate beams in the beam candidate group are valid beams based on measured radio performance or link quality.

Meanwhile, the transceiver device 160b in the display device 50 may classify the candidate beams in the beam candidate group into valid beams and invalid beams based on the measured radio performance or link quality and manage the same.

Meanwhile, in case in which there are valid beams among the candidate beams in the beam candidate group, the transceiver device 160b in the display device 50 may select a beam having the best link quality among the valid beams.

Meanwhile, in case in which a beam having a predetermined link quality or higher exists in a state in which the current beam is a valid beam, the transceiver device 160b in the display device 50 may change the beam.

Accordingly, it is possible to prevent a phenomenon in which a beam change is repeated in case in which there is a fluctuation in the measured link quality.

Meanwhile, if there is no valid beam and the measured link quality is greater than or equal to the minimum threshold, the transceiver device 160b in the display device 50 may select a candidate beam having the highest measured link quality from the beam candidate group. Accordingly, the link may be maintained.

Meanwhile, the transceiver device 160b in the display device 50 may perform beam selection based on the best beam in case in which there is no valid beam and the measured link quality of a plurality of candidate beams in the beam candidate group is less than the minimum threshold.

For example, if the link quality of all of the plurality of candidate beams in the candidate group is less than a minimum threshold, beam changing is meaningless, so the transceiver device 160b in the display device 50 may change the beam to the best beam having a high probability of being an LOS path.

Meanwhile, in a state in which the valid beam is changed to the invalid beam, in case in which the link quality of the invalid beam is measured to have a level of the valid beam, the transceiver device 160b in the display device 50 controls updating to the valid beam after a certain period of time, rather than immediately updating to the valid beam.

Accordingly, it is possible to filter a case of switching to a valid beam only momentarily, and eventually, stable management and update of a valid beam are possible.

Next, in case in which the wireless environment changes, the transceiver device 160b in the display device 50 may update the beam candidate group based on first beam tracking performed during a first period and second beam tracking performed during a second period longer than the first period.

That is, the transceiver device 160b in the display device 50 may update the beam candidate group based on the first beam tracking performed during the first period based on the wireless environment between the wireless media device 300 and the display device 50 or the second period longer than the first period.

For example, in case in which the change in the wireless environment is within a first range, the transceiver device 160b in the display device 50 may control to perform first beam tracking during the first period, and in case in which the change in the wireless environment is within a second range greater than the first range, the transceiver device 160b in the display device 50 may control to perform the second beam tracking during the second period longer than the first period.

Meanwhile, in case in which performing the first beam tracking, the transceiver device 160b in the display device 50 may perform beam tracking based on a plurality of candidate beams in the beam candidate group.

Meanwhile, in case in which performing second beam tracking, the transceiver device 160b in the display device 50 may update the beam candidate group by measuring the link quality of the beam candidate group and beams other than the beam candidate group. Accordingly, beam tracking can be efficiently performed. Furthermore, beam tracking can be efficiently performed depending on the wireless environment.

Meanwhile, the transceiver device 160b in the display device 50 may add the best beam selected based on the second beam tracking, the currently used beam, and the previous best beam into the beam candidate group and manage the same. Accordingly, it is possible to prepare for a case in which an incorrect beam is selected as the best beam due to a temporary change in the wireless environment.

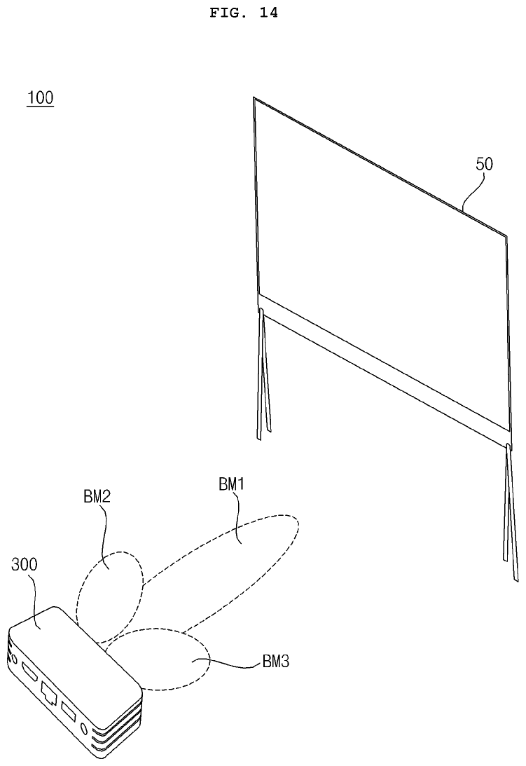

FIGS. 14 to 16 are drawings referred to in the description of FIG. 13.

FIG. 14 is a diagram illustrating that a plurality of beams are output from the wireless media device 300 to the display device 50.

Referring to the figure, the transceiver device 160a in the wireless media device 300 may transmit a plurality of beams BM1, BM2, BM3, . . . in different directions according to transmission angles.

For example, among the plurality of beams BM1, BM2, BM3, . . . , a first beam BM1 may be a beam corresponding to the LOS path, and a second beam BM2 or a third beam BM3 may be beams corresponding to a side robe.

Meanwhile, the transceiver device 160a may identify a plurality of regions for a beam candidate group, select candidate beams in some of the plurality of regions, and manage the same.

Accordingly, the transceiver device 160a may set a region to which the first beam BM1 belongs as a first region and set a region to which the second beam BM2 or the third beam BM3 belongs as a second region. The second region in this case may be a region in a vertical direction of the first region.

Meanwhile, in addition to the first region and the second region, the transceiver device 160a may set a third region which is a region disposed in a horizontal direction of the first region, and other fourth regions.

In addition, the transceiver device 160a may select candidate beams in the first to third regions, among the first to fourth regions, and manage a beam candidate group. Accordingly, beam tracking can be efficiently performed. Furthermore, beam tracking may be quickly performed using the beam candidate group.

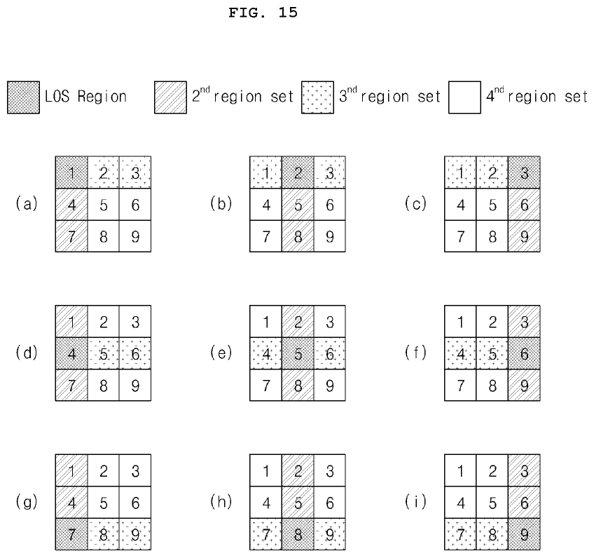

FIG. 15 is a diagram referred to describe a configuration of a beam candidate group.

Referring to the figure, the transceiver device 160a may identify 9 regions based on a 3×3 matrix for a beam candidate group, as shown in the figure.

Also, the transceiver device 160a may select candidate beams in 5 of the 9 regions and manage the same.

(a) of FIG. 15 illustrates that the LOS region is located in region ‘1’ among 9 regions.

The transceiver device 160a may set region ‘1’ as a first region, set region ‘4’ and region ‘7’, which are in a vertical direction of region ‘1’, as second regions, set region ‘2’ and region ‘3’, which are in a horizontal direction of region ‘1’, as third regions, and set the other regions as fourth regions.

(b) of FIG. 15 illustrates that the LOS region is located in region ‘2’, among 9 regions.

The transceiver device 160a may set region ‘2’ as a first region, set region ‘5’ and region ‘8’, which are in a vertical direction of region ‘2’, as second regions, set region ‘1’ and region ‘3’, which are in a horizontal direction of region ‘2’, as third regions, and set the other regions as fourth regions.

(c) of FIG. 15 illustrates that the LOS region is located in region ‘3’ among 9 regions.

The transceiver device 160a may set region ‘3’ as a first region, set region ‘6’ and region ‘9’, which are in a vertical direction of region ‘3’, as second regions, set region ‘1’ and region ‘2’, which are in a horizontal direction of region ‘3’, as third regions, and set the other regions as fourth regions.

(d) of FIG. 15 illustrates that the LOS region is located in region ‘4’ among 9 regions.

The transceiver device 160a may set region ‘4’ as a first region, set region ‘1’ and region ‘7’, which are in a vertical direction of the region ‘4’, as second regions, set regions ‘5’ and ‘6’, which are in a horizontal direction of region ‘4’, as third regions, and set the other regions fourth regions.

(e) of FIG. 15 illustrates that the LOS region is located in region ‘5’ among 9 regions.

The transceiver device 160a may set region ‘5’ as a first region, set region ‘2’ and region ‘8’, which are in a vertical direction of region ‘5’, as second regions, set region ‘4’ and region ‘6’, which are in a horizontal direction of region ‘5’, as third regions, and set the other regions as fourth regions.

(f) of FIG. 15 illustrates that the LOS region is located in region ‘6’ among 9 regions.

The transceiver device 160a may set region ‘6’ as a first region, set region ‘3’ and region ‘9’, which are in a vertical direction of region ‘6’, as second regions, set region ‘4’ and region ‘5’, which are in a horizontal direction of region ‘6’, as third regions, and set the other regions as fourth regions.

(g) of FIG. 15 illustrates that the LOS region is located in region ‘7’ among 9 regions.

The transceiver device 160a may set region ‘7’ as a first region, set region ‘l’ and the region ‘4’, which are in a vertical direction of region ‘7’, as second regions, set region ‘8’ and region ‘9’, which are in a horizontal direction of region ‘7’, as third regions, and set the other regions as fourth regions.

(h) of FIG. 15 illustrates that the LOS region is located in the region ‘8’ among the 9 regions.

The transceiver device 160a may set region ‘8’ as a first region, set region ‘2’ and region ‘5’, which are in a vertical direction of region ‘8’, as second regions, set region ‘7’ and region ‘9’, which are in a horizontal direction of region ‘8’, as third regions, and set the other regions as fourth regions.

(i) of FIG. 15 illustrates that the LOS region is located in the region ‘9’ among the nine regions.

The transceiver device 160a may set region ‘9’ as a first region, set region ‘3’ and region ‘6’, which are in a vertical direction of region ‘9’, as second regions, set region ‘7’ and region ‘8’, which are in a horizontal direction of region 9, as third regions, and set the other regions as fourth regions.

In (a) to (i) of FIG. 15, the transceiver device 160a may select one candidate beam in the first region, select 6 candidate beams in the second region, and select 4 candidate beams in the third region. Accordingly, beam tracking may be quickly performed using the beam candidate group.

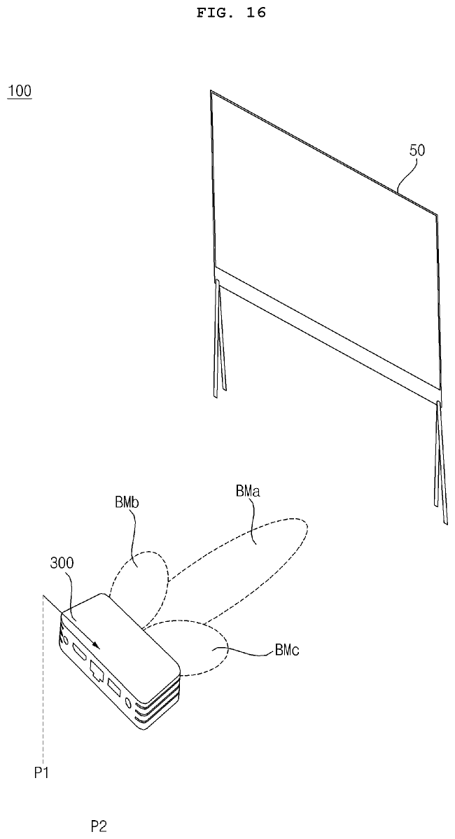

FIG. 16 is a diagram illustrating that a plurality of beams are output from the wireless media device 300 to the display device 50 in case in which the wireless media device 300 is moved.

Referring to the figure, the wireless media device 300 may be moved from a first location P1 to a second location P2.

Meanwhile, the transceiver device 160a in the wireless media device 300 may transmit a plurality of beams BMa, BMb, BMc, . . . in different directions according to transmission angles.

Compared to the plurality of beams BM1, BM2, BM3, . . . of FIG. 14, according to the movement of the wireless media device 300, a beam corresponding to the LOS path, among the plurality of beams BMa, BMb, BMC, . . . may change.

For example, among the plurality of beams BMa, BMb, BMC, . . . , a first beam BMa may be a new LOS beam according to the movement of the wireless media device 300, and a second beam BM2 or a third beam BM3 may be a beam corresponding to a side robe of the new LOS beam.

Accordingly, in case in which at least one of the wireless media device 300 or the display device 50 is moved while performing beam tracking based on the plurality of candidate beams in the beam candidate group, the transceiver device 160a may measure link quality for the beam candidate group and beams other than the beam candidate group and update the beam candidate group.

For example, in case in which a change in a wireless environment is within a first range, the transceiver device 160a may control to perform first beam tracking based on a plurality of candidate beams in the beam candidate group during a first period, and in case in which the change is in the wireless environment is within a second range greater than the first range, the transceiver device 160a may control to perform second beam tracking based on the beam candidate group and beams other than the beam candidate group during a second period, which is longer than the first period. Accordingly, beam tracking can be efficiently performed according to changes in the wireless environment.

Meanwhile, the transceiver device 160a may add the best beam selected based on the second beam tracking, the currently used beam, and the previous best beam into the beam candidate group and manage the same. Accordingly, it is possible to prepare for a case in which an incorrect beam is selected as the best beam due to a temporary change in the wireless environment.

While the disclosure has been described with reference to the embodiments, the disclosure is not limited to the above-described specific embodiments, and it will be understood by those skilled in the related art that various modifications and variations may be made without departing from the scope of the disclosure as defined by the appended claims, as well as these modifications and variations should not be understood separately from the technical spirit and prospect of the disclosure.

What is claimed is:

1. A wireless media device comprising:
a signal processing device configured to process an image signal or an audio signal; and
a transceiver device configured to wirelessly transmit a signal from the signal processing device to a display device,
wherein the transceiver device is configured to select a beam candidate group based on link quality between the wireless media device and the display device, manage the beam candidate group, and perform beam selection based on a plurality of candidate beams in the beam candidate group.

2. The wireless media device of claim 1, wherein the transceiver device is configured to periodically measure the link quality of the plurality of candidate beams in the beam candidate group and update the plurality of candidate beams in the beam candidate group based on the measured link quality.

3. The wireless media device of claim 1, wherein the transceiver device is configured to perform the beam selection within the beam candidate group in case in which there is a valid beam among the plurality of candidate beams in the beam candidate group or in case in which measured link quality is greater than or equal to a reference value.

4. The wireless media device of claim 1, wherein the transceiver device is configured to perform the beam selection based on a best beam in case in which link quality measured for the plurality of candidate beams in the beam candidate group is less than a reference value.

5. The wireless media device of claim 1, wherein the transceiver device is configured to update the beam candidate group based on first beam tracking performed during a first period or second beam tracking performed during a second period longer than the first period, based on a wireless environment between the wireless media device and the display device.

6. The wireless media device of claim 1, wherein the transceiver device is configured to manage the beam candidate group through beam grouping.

7. The wireless media device of claim 1, wherein the transceiver device is configured to identify a plurality of regions for the beam candidate group, select candidate beams from some of the plurality of regions, and manage the selected candidate beams.

8. The wireless media device of claim 7, wherein
the transceiver device is configured to:
select a first number of beams as candidates in a first region to which a first beam belongs among the plurality of regions,
select a second number of beams as candidates in a second region adjacent to the first region in a first direction, among the plurality of regions, and
select a third number of beams as candidates in a third region adjacent to the first region in a second direction, among the plurality of regions,
wherein the second number is greater than the first number, and the second number is greater than the third number.

9. The wireless media device of claim 8, wherein the plurality of regions further include a fourth region in which the candidate beam is not selected.

10. The wireless media device of claim 1, wherein the transceiver device is configured to identify 9 regions based on a 3×3 matrix for the beam candidate group, select candidate beams from 5 regions among the 9 regions, and manage the selected candidate beams.

11. The wireless media device of claim 1, wherein the transceiver device is configured to select a candidate beam having a highest measured link quality in the beam candidate group in case in which there is a valid beam in the plurality of candidate beams in the beam candidate group and measured link quality is greater than or equal to a reference value.

12. The wireless media device of claim 5, wherein the transceiver device is configured to perform the first beam tracking based on the plurality of candidate beams in the beam candidate group.

13. The wireless media device of claim 5, wherein the transceiver device is configured to update the beam candidate group by measuring link quality for the beam candidate group and beams other than the beam candidate group, in case in which performing the second beam tracking.

14. The wireless media device of claim 5, wherein the transceiver device is configured to add a best beam selected based on the second beam tracking, a beam currently in use, and a previous best beam to the beam candidate group and manage the beams.

15. The wireless media device of claim 1, wherein in case in which at least one of the wireless media device or the display device is moved while performing beam tracking based on the plurality of candidate beams in the beam candidate group, the transceiver device is configured to update the beam candidate group by measuring link quality for the beam candidate group and beams other than the beam candidate group.

16. The wireless media device of claim 1, wherein the transceiver device is configured to:
transmit a first signal based on a beam having a first shape in which a sector is sequentially varied during a first period,
receive a second signal based on the beam having the first shape from the display device during a third period according to selection of the wireless media device of the display device during a second period,
approve association with the display device based on network address information in the second signal during a fourth period,
transmit a third signal based on a beam having a second shape at an angle smaller than that of the first shape during a fifth period, and
transmit wireless media to the display device based on the beam having the second shape during a sixth period.

17. A wireless media device comprising:
a signal processing device configured to process an image signal or an audio signal; and
a transceiver device configured to wirelessly transmit a signal from the signal processing device to a display device,
wherein the transceiver device is configured to identify a plurality of regions for a beam candidate group based on link quality between the wireless media device and the display device, select candidate beams from some of the plurality of regions, and manage the selected candidate beams.

18. The wireless media device of claim 17, wherein
the transceiver device is configured to
select a first number of beams as candidates in a first region to which a first beam belongs among the plurality of regions,
select a second number of beams as candidates in a second region adjacent to the first region in a first direction, among the plurality of regions, and
select a third number of beams as candidates in a third region adjacent to the first region in a second direction, among the plurality of regions,
wherein the second number is greater than the first number, and the second number is greater than the third number.

19. An image display apparatus comprising:
a display device; and
a wireless media device configured to wirelessly communicate with the display device,
wherein the wireless media device comprises:
a signal processing device configured to process an image signal or an audio signal; and
a transceiver device configured to wirelessly transmit a signal from the signal processing device to a display device,
wherein the transceiver device is configured to select a beam candidate group based on link quality between the wireless media device and the display device, manage the beam candidate group, and perform beam selection based on a plurality of candidate beams in the beam candidate group.

20. The image display apparatus of claim 19, wherein the transceiver device is configured to identify a plurality of regions for a beam candidate group based on the link quality between the wireless media device and the display device, select candidate beams from some of the plurality of regions, and manage the selected candidate beams.
